(19) United States
(12) Patent Application Publication
(10) Pub. No.: US 2026/0134783 A1
(43) Pub. Date: May 14, 2026

(54) SYSTEM AND METHOD FOR MOTIVATING OR DRIVING WEIGHT LOSS

(71) Applicant: Freeman Bosley, JR., St Louis, MO (US)

(72) Inventor: Freeman Bosley, JR., St Louis, MO (US)

(21) Appl. No.: 19/313,850

(22) Filed: Aug. 28, 2025

Related U.S. Application Data
(60) Provisional application No. 63/719,600, filed on Nov. 12, 2024.

(51) Int. Cl. G09B 5/02

(52) U.S. Cl. CPC G09B 5/02

(57) ABSTRACT

In one example, a method includes receiving an indication of a body characteristic of a user collected by a sensor and an identifier of an actual choice by the user; deriving a level of health of the user from at least the body characteristic; correlating the identifier to an amount of a nutrient of a food item, or an amount of energy used by a physical activity; deriving an actual reward for actual choice, wherein the actual reward comprises an amount of money, credit or redeemable tokens; implementing the actual reward by providing the user or taking from the user the amount of money, credit or redeemable tokens; and transmitting to a portable device of the user, an indication of the actual reward to enable its presentation to the user.

### BACKGROUND

Throughout the United States and many other countries, obesity has reached crisis levels that have increased the urgency behind efforts to identify solutions to reducing it. Unfortunately, a combination of a sedentary Western lifestyle and a Western diet full of processed foods and snacks have conspired over multiple decades to exacerbate the problem.

Regarding physical activity, the advent and widespread use of computer technology has greatly changed many working environments to those in which work personnel sit at desks for extended periods of time with little physical activity being required of them. A similar situation has developed for leisure activities where pleasure is now more often sought from “binge watching” movies, or from playing video games in which little physical exertion is required beyond manipulating hand-operated controls.

Regarding diet, advances in food-related chemistry have enabled the creation of an ever-widening variety of foods made from chemical compounds that simulate the taste of natural ingredients, thereby decreasing the variety of natural ingredients used in many foods. By way of example, various whole grain ingredients have been replaced with such food-related chemical compounds, such as the widespread replacement of whole grain sugar with high-fructose corn syrup. Such food-related compounds often provide far less nutrition than the natural ingredients that they replace, as well as frequently providing larger amounts of unhealthy types of fat, sugar and/or cholesterol. Such food-related compounds are also often cheaper than the natural ingredients they replace, which has aided in encouraging an overuse of such compounds to heighten the degree of pleasure experienced by eating the foods that contain them.

Also, advances in food packaging and food preservation have enabled the creation of an increasing variety of snack foods that are able to be stored for extended periods of time at checkout counter displays and within vending machines. This has also enabled the creation of meal items and whole meals that are able to be prepared and/or pre-cooked at factory facilities, before being provided to so-called “fast-food” restaurants where relatively few preparation and/or cooking steps remain to be performed before serving. As a result, the focus has shifted to serving food very quickly, instead of providing nutritious food.

These and other factors have lead to the creation of a Western food culture that encourages the speedy and convenient provision of foods that are lacking in nutrients, while providing highly stimulating levels of particular tastes coupled with damaging levels of unhealthy types of fat, sugar and cholesterol. Grocery stores and restaurants that offer healthier foods have struggled to compete in such an environment, leading many to focus on identifying and serving population areas where profitability is easier to achieve. As a result, so-called “food deserts” have emerged, even in densely populated areas, where no grocery stores and/or no restaurants providing nutritious foods exist. This creates a self-reinforcing situation in which the people in such places become even more habituated toward eating the unhealthy foods that they are able to find in such places.

Again, increasingly urgent efforts have long been underway to find ways to counteract the resulting obesity crisis, but with only limited success.

### BRIEF DESCRIPTION OF THE DRAWINGS

The drawings illustrate only particular examples of the disclosure and therefore are not to be considered limiting of their scope. The principles here are described and explained with additional specificity and detail through the use of the accompanying drawings.

FIG. 1 illustrates an automated health rewards system to encourage weight loss according to examples of the present disclosure.

FIGS. 2A, 2B, 2C, 2D and 2E, taken together, illustrate aspects of components of such a health rewards system to gather body and lifestyle characteristics, and to both derive and implement rewards corresponding to health-related choices, according to examples of the present disclosure.

FIGS. 3A, 3B, 3C, 3D and 3E, taken together, illustrate aspects of the automated derivation and use of rewards to encourage weight loss according to examples of the present disclosure.

### DETAILED DESCRIPTION

A health rewards system may include a combination of a portable device carried by a user, one or more stationary devices installed at various food purveying locations frequented by the user, and one or more servers that may cooperate to use positive and/or negative rewards to encourage the user to make health-related choices (e.g., choices of food and/or of physical activity) that improve the user's health. Sensors associated with the portable, and/or the one or more stationary devices may collect status data indicative of various body characteristics and/or of some lifestyle characteristics of the user. The portable device, and/or the one or more stationary devices, may also collect choices data indicative of prospective health-related choices that are being considered by the user, and/or actual health-related choices that are ultimately made by the user. The one or more servers may analyze the status data and/or choices data to provide the user with indications of positive and/or negative prospective rewards that may be presented to the user in response to prospective choices being considered, and/or may implement a positive or negative actual reward in response to an actual choice that is ultimately made by the user.

It may be that the status data includes indications of such body characteristics of the user as their current weight, and/or that the analysis includes an evaluation of the user's body mass index (BMI) or variant thereof. Alternatively or additionally, the status data and/or the analysis thereof may involve other body characteristics of the user, including and not limited to, the user's waist circumference or other body dimension, blood pressure, cardiovascular activity, pulmonary activity, gastrointestinal activity, biochemical changes, etc. It may be that multiple instances of the choices data provides indications of a history of actual choices made by the user (including choices of food and/or physical exercise), and/or that the analysis includes an evaluation of nutrient intake and/or energy usage resulting from those choices.

The analyses that are performed based on the status data and/or the choices data may include the use of one or more health models that may be selected based on various body characteristics of the user, such as physical height, age, gender, etc. Some of such body characteristics may be collected by sensors of portable and/or stationary devices of the health rewards system, while others of such body characteristics may be collected by medical professionals concerning the user during medical checkups, etc. Alternatively or additionally, it may be that at least a subset of such health models are based on machine learning techniques that may enable adaptation to various characteristics of the user and/or other persons with similar characteristics.

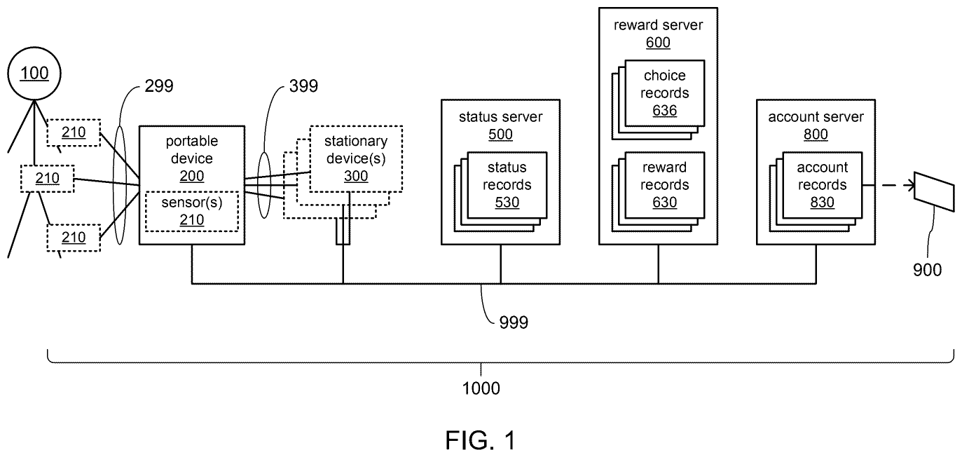

At least a portion of the health rewards system may be owned and/or operated by such entities as a government, an insurance company, a bank or other financial institution, and/or an employer of the user. Thus, it may be that different components of the system may be owned and/or operated by different entities. The positive and/or negative rewards may include, and are not limited to, increases and/or decreases in taxes paid by the user, increases and/or decreases in insurance expenses paid by the user, increases and/or decreases in job-related pay and/or other job-related benefits provided to the user, increase and/or decreases in some type of redeemable token, and/or increases and/or decreases in time periods during which the user may be granted a break from interacting with the system. FIG. 1 presents a high level block diagram of a health rewards system 1000 in which the depicted user 100 thereof may be encouraged to make health-related choices (e.g., choices of foods to eat and/or physical activities to engage in) that improve the health of the user 100. In so doing, the user 100 may be presented with differing positive and/or negative prospective rewards that are correlated to differing prospective health-related choices that the user 100 is considering. In this way, the user 100 is able to consider tradeoffs between prospective choices of foods and/or physical activities that they may be considering, and corresponding prospective rewards. Each of those positive and/or negative prospective rewards may be at least partially determined by the current level of health of the user 100.

In the example of FIG. 1, the system 1000 may include a portable device 200 carried by the user 100, one or more sensors 210 associated with the portable device 200, one or more stationary devices 300 at fixed locations frequented by the user 100, a status server 500, a reward server 600, and/or an account server 800 that are coupled via a network 999. As also depicted, the system 1000 may include a credit or debit card 900 that may be carried by the user 100, and that may be associated with an account of the user 100 for which data is maintained by the account server 800.

The portable device 200 may be any of a variety of portable devices that may be carried by the user 100, including and not limited to, a smart phone, a personal data assistant (PDA), a tablet computer, a wearable computer, etc. As will be explained in greater detail, the portable device 200 may serve to provide a user interface (UI) by which the user 100 may interact remotely with one or more other devices of the system 1000 (e.g., one or more of the servers 500, 600 and/or 800). By way of example, and as will be explained in greater detail, the user 100 may provide other device(s) of the system 1000 with status data concerning one or more body characteristics of the user 100 through the portable device 200 and/or the one or more stationary devices 300, and the user 100 may be presented with audio and/or visual prompts through the UI of the portable device 200 to do so. By way of another example, and as will also be explained in greater detail, the user 100 may provide other device(s) of the system 1000 with choices data concerning health-related choices through the UI of the portable device 200, and/or the user 100 may be presented with indications of positive and/or negative rewards that may be associated with such choices through the UI of the portable device 200.

As depicted, the portable device 200 may incorporate and/or be otherwise accompanied by the one or more sensors 210. More specifically, it may be that the portable device 200 directly incorporates at least one of the sensor(s) 210. Alternatively or additionally, it may be that at least one of the sensor(s) 210 is physically separate from the portable device 200, but is wirelessly coupled to the portable device 200 (e.g., by the depicted personal area network (PAN) 299). As will be explained in greater detail, each sensor 210 may collect status data concerning one or more body characteristics of the user 100 (e.g., weight, waist circumference or other body dimension, hours when awake and/or asleep, blood pressure, cardiovascular activity, pulmonary activity, etc.). Further, it may be that one or more lifestyle characteristics that reflect some health-related choices of the user are also collected via one or more of the sensor(s) 210. The portable device 200 may then relay such status data to at least the status server 500 via the network 999.

Each of the one or more stationary devices 300 may be any of a variety of devices that may be installed at any of a variety of stationary locations. By way of example, a stationary device 300 may be a scale installed at the home of the user 100, or at a grocery store or restaurant frequented by the user 100. In a manner similar to the combination of the portable device 200 and the one or more sensors 210, each stationary device 300 may also serve to collect status data concerning one or more current body characteristics of the user 100. And similarly, each stationary device 300 may then relay such status data to at least the status server 500, either directly via the network 999, or indirectly through a local network 399 and the portable device 200.

The status server 500 may maintain a set of status records 530, in which there may be a separate status record 530 for each user of multiple users of the system 1000, including a status record 530 for the depicted user 100. Each status record 530 may include a collection of health-related data concerning its corresponding user. As will be explained in greater detail, the one of the status records 530 that corresponds to the depicted user 100 may include received instances of status data concerning body characteristics of the user 100 (and/or some lifestyle characteristics of the user 100) that are collected over time by the depicted sensor(s) 210 and/or by the depicted stationary device(s) 300. As will also be explained in greater detail, in response to receiving newer instances of the status data, the status server 500 may repeatedly perform various analyses of such status data to repeatedly derive a new (updated) level of health of the user 100. As each such level of health of the user 100 is derived, health data that includes an indication of that current level of health of the user 100 may be relayed by the status server 500 to the reward server 600 via the network 999. Additionally, it may be that the status server 500 cooperates with the portable device 200 to present audio and/or visual prompts to the user 100 to employ the depicted sensor(s) 210 and/or the depicted stationary device(s) 300 to collect and provide such new instances of the status data to the status server 500.

The reward server 600 may maintain a set of reward records 630, in which there may be a separate reward record 630 for each user of multiple users of the system 1000, including a reward record 630 for the depicted user 100. Each reward record 630 may include a collection of data concerning the level of health and/or health-related choices of its corresponding user. As will be explained in greater detail, the one of the reward records 530 that corresponds to the depicted user 100 may include received instances of choices data relayed to the reward server 600 over time by the depicted portable device 200 concerning prospective choices being considered and/or actual choices that were ultimately made by the user 100, including food-related choices and/or physical activity choices. As will also be explained in greater detail, in response to receiving newer instances of choices data indicating prospective choices being considered by the user 100, the reward server 600 may repeatedly perform various analyses of those prospective choices, together with recently received instances of the health data, to repeatedly derive prospective rewards for those prospective choices. As such prospective rewards are derived, corresponding instances of reward data that include indications of such prospective rewards may be provided by the reward server 600 to the portable device 200 via the network 999 for presentation to the user 100. Alternatively or additionally, in response to receiving newer instances of choices data indicating the actual choices that were ultimately made by the user 100, the reward server 600 may provide, to the account server 800 via the network 999, corresponding instances of reward data that include indications of corresponding actual rewards that are to be implemented.

As will additionally be explained in greater detail, it may be that the instances of the choices data use identifiers to specify prospective and/or actual choices. In this way, the need to consume data bandwidth and/or data storage space with instances of choices data that include relatively detailed descriptions of each choice may be obviated. In such embodiments, it may be that the reward server 600 may additionally maintain a set of choice records 636, in which there may be a separate choice record 636 for each health-related choice. Each choice record 636 may correlate a single identifier to such a detailed description of the corresponding health-related choice. By way of example, for a particular choice of a food item, the identifier may be correlated to a description of amounts of various nutrients provided by that food item (e.g., amounts of vitamins, minerals, salt, sugars, fats, cholesterols, etc.). By way of another example, for a particular physical activity (or for a specified duration of a particular physical activity), the identifier may be correlated to one or more amounts that describe an amount of energy that is used (e.g., an amount of energy used in joules; an amount of calories burned; an amount of fats, sugars and/or cholesterol expended; etc.).

The account server 800 may maintain a set of account records 830, in which there may be a separate account record 830 for each user of multiple users of the system 1000, including an account record 830 for the depicted user 100. Each account record 830 may include indications of actual rewards that have actually been implemented by the account server 800. As will be explained in greater detail, the implementation of actual rewards indicated in the account record 830 of the user 100 may be associated with the depicted credit or debit card 900 by which the user 100 may be provided with at least a subset of those actual rewards that include financial incentives and/or disincentives. As will also be explained in greater detail, in embodiments that include the card 900, it may also be that indications of actual choices made by the user 100 are gleaned from monitoring the purchases made by the user 100 through use of the card 900. In response to receiving such indications of such purchases, the account server 800 may provide instances of choices data that convey indications of such actual choices back to the reward server 600 via the network 999, thereby causing the reward server 600 to derive a corresponding actual reward that may be conveyed back to the account server 800 for implementation.

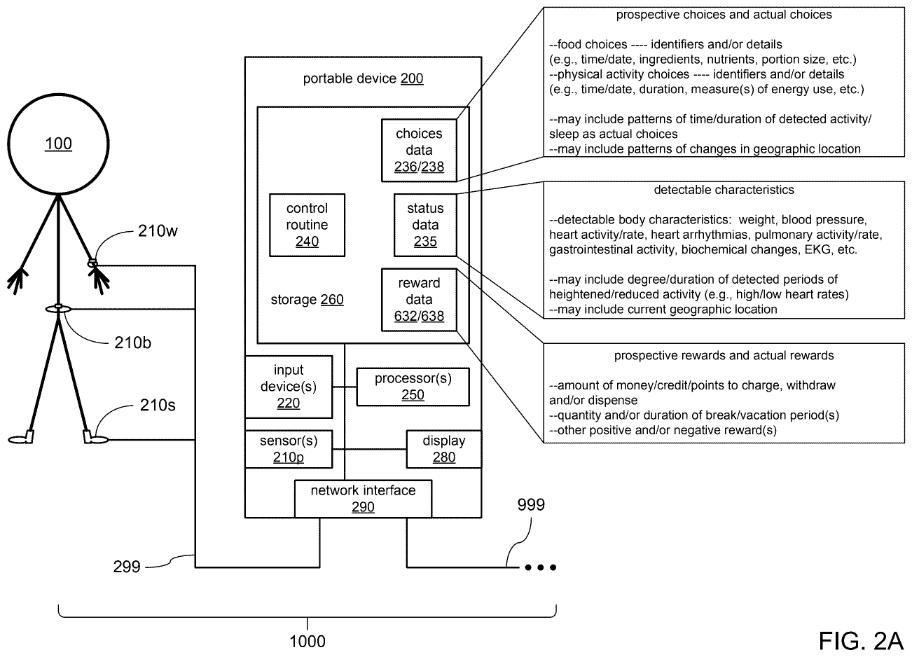

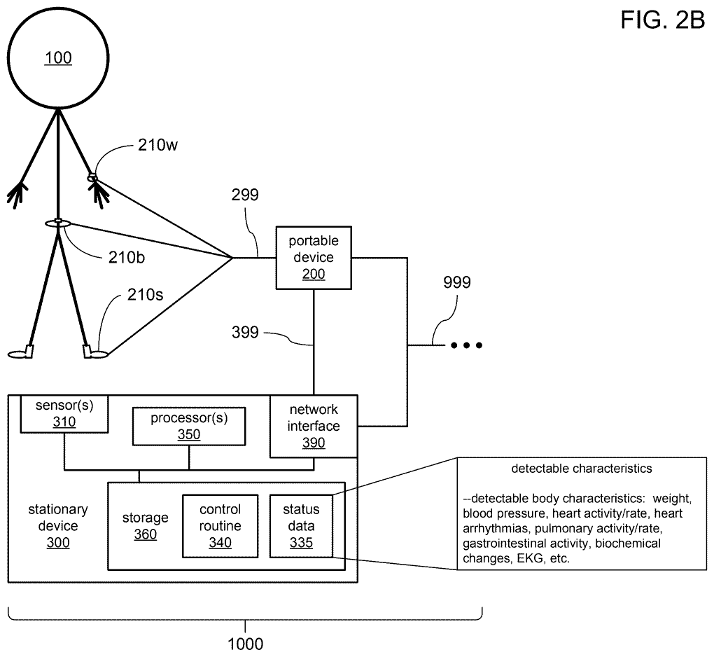

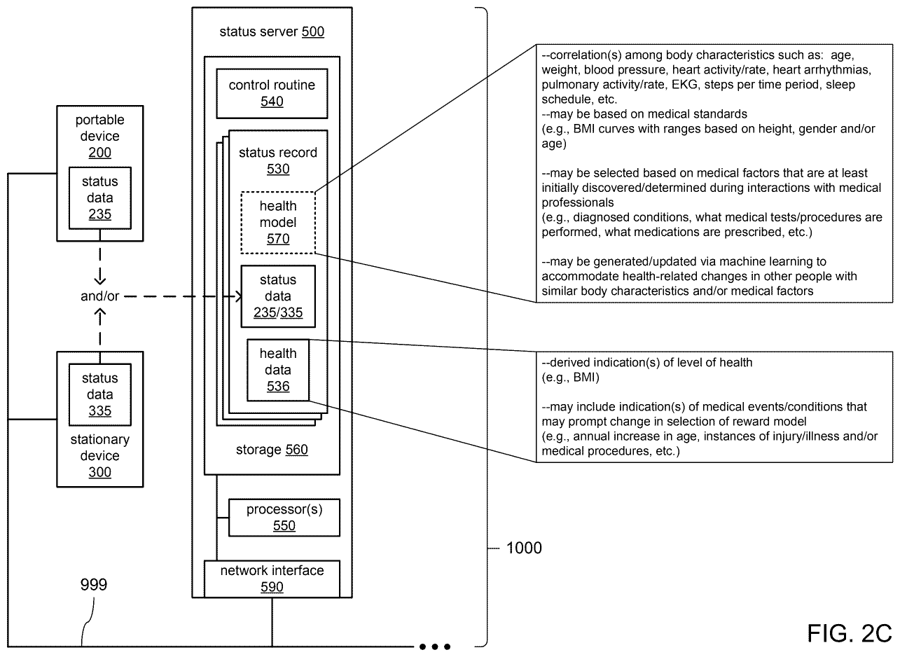

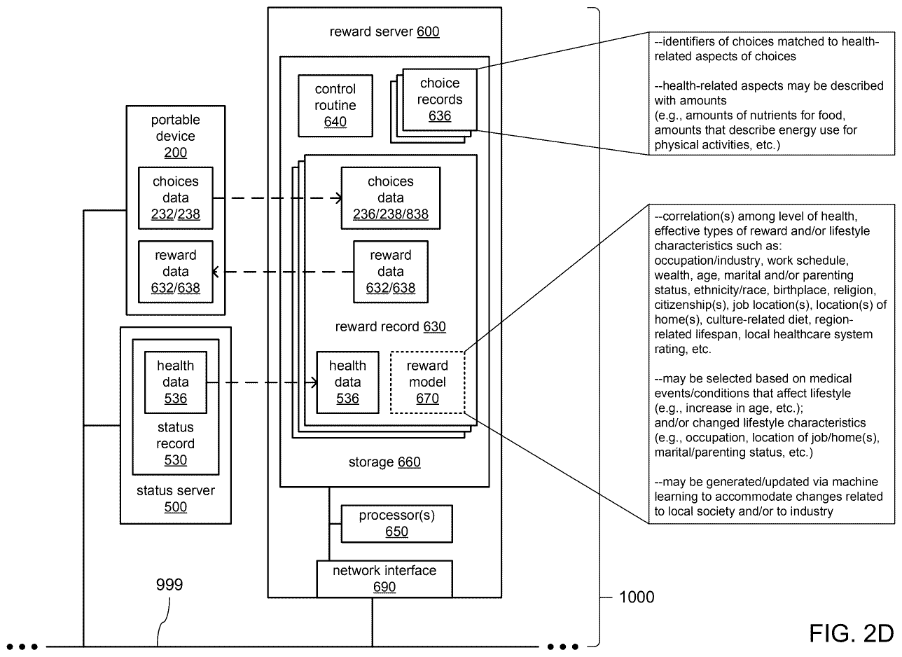

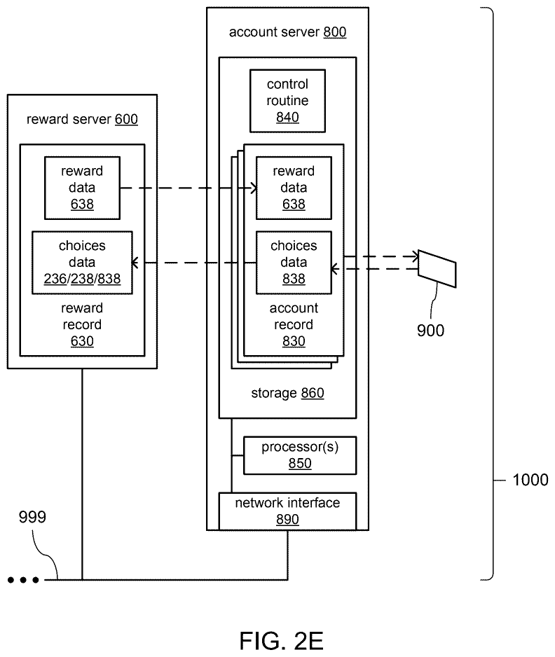

FIGS. 2A-E, taken together, depict aspects of cooperation among the devices 200, 210, 300, 500, 600 and/or 800, through the network(s) 299, 399 and/or 999, to encourage the user 100 to make health-related choices that are at least conducive to improving the health of the user 100 (e.g., causing the user 100 to lose weight). More specifically, FIGS. 2A-E depict, in greater detail, aspects of the corresponding exchanges of commands and/or data among these devices. FIGS. 2A-E also depict aspects of making various determinations concerning the user 100, and acting on those various determinations.

The network 999 may be implemented using any of a variety of wireless and/or cabling-based network technologies, including and not limited to, Bluetooth, Wi-Fi, cellular signaling, twisted-pair electrical cabling, coaxial electrical cabling, and/or fiber optic cabling. Such wireless and/or cabling-based technologies may adhere to any of a wide variety of specifications, including and not limited to, Ethernet and/or TCP/IP. In some embodiments, it may be that one or more portions of the network 999 include, and/or otherwise extend through, portions of the Internet.

Each of the personal area network (PAN) 299 and the local area network (LAN) 399 may be similarly implemented using any of a variety of wireless and/or cabling-based network technologies, including and not limited to, Bluetooth, Wi-Fi, cellular signaling, twisted-pair electrical cabling, coaxial electrical cabling, and fiber optic cabling. Alternatively or additionally, in some embodiments, it may be that one or more portions of the PAN 299 employs one or more portions of the body of the user 100 as a transmission medium for low voltage and/or low current signals among the portable device 200 and/or the one or more sensors 210 that are not directly incorporated into the portable device 200.

Turning to FIG. 2A, the portable device 200 may include one or more of sensor(s) 210p, input device(s) 220, processor(s) 250, a storage 260, a display 280, and/or a network interface 290 to couple the portable device 200 to the network(s) 299, 399 and/or 999. The processor(s) 250 may be communicatively coupled to others of these components, via one or more buses and/or other form(s) of interconnect within the portable device 200, to enable the exchange of executable instructions and/or data thereamong via the exchange of electrical, optical, magnetic and/or other transmissions. The storage 260 may store status data 235, choices data 236 and/or 238, and/or reward data 632 and/or 638 that may be associated with the user 100. The storage 260 may also store a control routine 240.

As previously discussed, the one or more sensors 210p may be directly incorporated into the portable device 200, and may each be any of a variety of types of sensor capable of collecting (e.g., detecting and/or measuring) any of a variety of body characteristics of the user 100. Such body characteristics may include, and are not limited to, weight, waist circumference or other body dimensions, blood pressure, heart rate, electrical cardiovascular activity (EKG), other aspects of cardiovascular activity (e.g., ultrasound scanning, audible sounds emitted by valves and/or blood flow, etc.), aspects of pulmonary activity (e.g., ultrasound scanning, audible sounds emitted by breathing, etc.), etc.

As also previously discussed, and either in addition to or in lieu of directly incorporating the one or more of the sensors 210p, the portable device 200 may be accompanied by one or more other sensors 210 that are physically separate from the portable device 200, but that are wirelessly coupled to the portable device 200 via the PAN 299. Again, such other sensors 210 may be carried on the body of the user 100, such as the depicted wrist watch sensor 210w, the depicted belt sensor 210b and/or the depicted shoe sensor 210s. Thus, it may be that such other sensors 210 may be capable of collecting (e.g., detecting and/or measuring) one or more of such a variety of body characteristics of the user 100 continuously, and/or at recurring intervals of time over a relatively lengthy period of time (e.g., multiple hours, one or more full days). Such opportunity and/or ability to collect body characteristics continuously and/or at recurring intervals over time may enable the collection of some lifestyle characteristics, frequency and/or duration of periods of time during which the user 100 may engage in physical activities (e.g., jogging, sports, etc.), frequency and/or duration of periods of sleep, etc.

Alternatively or additionally, such other sensors 210 may be capable of normally being carried together with or within the portable device 200, and then deployed for a relatively brief period of time to perform such detection and/or measurement. Thus, it may be that such other sensors may not be meant to be used for such ongoing collection of body and/or lifestyle characteristics.

In embodiments in which the weight of the user 100 is a body characteristic that is collected (e.g., measured for use in deriving BMI), it may be that the portable device 200 is, itself, able to be used as a portable scale for weighing the user 100. More specifically, the portable device 200 may be a tablet computer, laptop computer, or other device that incorporates a strain gauge (or other weight measuring component) that serves as a sensor 210p, and the portable device 200 may be physically shaped and/or sized to be amenable to allowing the user 100 to stand, sit and/or otherwise support at least a portion of their body thereon to enable their current weight to be collected.

Alternatively or additionally in embodiments in which the weight of the user 100 is a body characteristic that is collected, it may be that the depicted shoe sensor 210s incorporates such a weight measuring sensor component. It may be that the wearing of the shoe sensor 210s, while the user 100 stands on just the one foot that is within the shoe sensor 210s, enables their weight to be collected.

In embodiments in which the circumference of the waist of the user 100 is a body characteristic that is collected, it may be that the belt sensor 210b incorporates such a circumference measuring sensor component. It may be that the wearing of the belt sensor 210b enables such a measurement. As will be familiar to those skilled in the art, in the years following the development of BMI, questions have arisen concerning the degree to which BMI is truly effective as a tool to evaluate and/or indicate a level of health of a person. This has given rise to various efforts to improve upon the use of BMI by using another physical dimension such as a circumference of the waist of a person, either in addition to BMI or as an alternative to BMI (e.g., waist-to-height ratio (WHtR)). In some of such embodiments where weight is still used (e.g., where BMI is still at least partially relied on), it may be that the weight and the circumference of the waist of the user 100 are captured at different times and/or with difference frequency. By way of example, it may be that the weight of the user 100 may be measured using a scale at the home of the user 100 (e.g., an embodiment of the stationary device 300 that the user 100 is able use to weigh himself/herself at home) once a day, while the circumference of the waist of the user 100 is able to be measured using the belt sensor 210b on each occasion where the user 100 is considering a health-related choice (e.g., considering what to eat and/or what physical activity to engage in).

In embodiments in which the temperature of the user 100 is a body characteristic that is collected, it may be that the portable device 200 incorporates a thermal imaging camera, an infrared sensor, or other temperature measuring component that serves as a sensor 210p. It may be that the user 100 pointing that sensor 210p at their own forehead enables their temperature to be collected.

In embodiments in which the cardiovascular activity of the user 100 is a body characteristic that is collected, it may be that the wrist watch sensor 210w incorporates electrical contacts, infrared and/or other optical sensor components, etc. to detect cardiovascular electrical activity and/or blood flow activity. It may be that the user 100 wearing the wrist watch sensor 210w on a wrist enables such aspects of their cardiovascular activity to be collected.

Regardless of what body characteristic(s) are collected, and regardless of what type(s) and/or combination(s) of sensors 210 are used to do so, and as will be explained in greater detail, indications of such collected body characteristics may be stored as one or more instances of status data 235 within the storage 260.

The input device(s) 220 may include one or more manual input devices that enable the user 100 to manually enter information, such as various manually operable controls, including and not limited to, individual switches, buttons, knobs, etc.; a keypad/keyboard; a pointing device (e.g., a mouse, a trackball, a touchpad, etc.); etc. Alternatively or additionally, the input device(s) 220 may include one or more non-manual input devices (e.g., a camera operable to capture images of barcodes and/or to capture text) that enable the capture of information encoded within one-dimensional and/or two-dimensional bar codes (e.g., QR codes); information presented in human-readable text; information stored within radio frequency identification (RFID) tags; magnetically stored information (e.g., information stored within magnetic strips carried by cards, etc.), etc.

It should be noted that the display 280 may be a touchscreen display such that the display is able to serve as both a visual output device for the visual presentation of information to the user 100 and a manual input device that may be used by the user 100 to manually enter information, either in addition to or in lieu of, the portable device 200 incorporating manual input device(s) 220. It should also be noted that the portable device 200 may incorporate one or more components for presenting information to the user 100, either in addition to or in lieu of, the portable device 200 incorporating the display 280 (e.g., one or more speakers to present information audibly).

Regardless of the of what type(s) and/or combination(s) of input devices 220 are used to receive input from the user 100, and as will be explained in greater detail, indications of such input may be stored as one or more instances of choices data 236 within the storage 260. More specifically, it may be that health-related choices may be assigned identifiers that are able to be manually entered (e.g., via a keyboard) and/or entered non-manually (e.g., by scanning a barcode), such that instances of the choices data 236 are caused to include such identifiers.

The processor(s) 250 may each be any of a wide variety of types of processor that are configured to perform instruction-based processing that entails the execution of sequences of instructions, including and not limited to central processing units (CPUs), graphics processing units (GPUs), microcontrollers, sequencers, etc. The processor(s) 250 may each incorporate any of a variety of features to enhance speed and/or efficiency of processing operations. Such features may include and are not limited to, multi-threading support, multiple processing cores, single-instruction multiple-data (SIMD) support, directly integrated memory control functionality, and/or various modes of operation by which speed of execution of instructions may be dynamically altered.

The storage 260 may be based on any of a variety of storage technologies that provide relatively high speeds of access, but which require the continuous provision of electric power to retain any data and/or routines stored therein. Such technologies may include, and are not limited to, random-access memory (RAM), dynamic RAM (DRAM), Double-Data-Rate DRAM (DDR-DRAM), synchronous DRAM (SDRAM), static RAM (SRAM), etc. Alternatively or additionally, the storage 260 may be based on any of a variety of storage technologies that may not be capable of providing such relatively high speeds of access, but which may be capable of storing with greater density, and/or capable of retaining data and/or routines stored therein regardless of whether electric power is continuously provided. Such technologies include, and are not limited to, read-only memory (ROM), erasable programmable ROM (EPROM), electrically erasable programmable ROM (EEPROM), flash memory, magnetic or optical cards, one or more individual ferromagnetic disk drives, or a plurality of storage devices organized into one or more arrays (e.g., multiple ferromagnetic disk drives organized into a Redundant Array of Independent Disks array, or RAID array).

The network interface 290 may be capable of employing any of a variety of wireless communications technologies that may be associated with the networks 299, 399 and/or 999. Such technologies may include, and are not limited to, radio frequency transmissions, transmissions incorporated into electromagnetic fields by which electric power may be wirelessly conveyed, and/or any of a variety of types of optical (e.g., infrared) and/or audio (e.g., ultrasonic) transmission. Additionally, the network interface 290 may be configured to engage in communications that adhere in timings, in protocols and/or in other aspects to one or more known and widely used standards, including and not limited to IEEE 802.11a, 802.11ad, 802.11ah, 802.11ax, 802.11b, 802.11g, 802.16, 802.20; Bluetooth; ZigBee; or a cellular radiotelephone service such as GSM with General Packet Radio Service (GSM/GPRS), CDMA/1×RTT, Enhanced Data Rates for Global Evolution (EDGE), Evolution Data Only/Optimized (EV-DO), Evolution For Data and Voice (EV-DV), High Speed Downlink Packet Access (HSDPA), High Speed Uplink Packet Access (HSUPA), 4G LTE, 5G, etc.

Alternatively or additionally, the network interface 290 may be capable of employing any of a variety of cabling-based communications technologies by which electrical and/or optical signals may be used to exchange information through any of a variety of electrical and/or optical cabling. Also alternatively or additionally, the network interface 290 may be configured to engage in communications that adhere in timings, in protocols and/or in other aspects to one or more known and widely used standards, including and not limited to RS-232C, RS-422, Universal Serial Bus (USB), Ethernet (IEEE-802.3) or IEEE-1394.

Also alternatively or additionally, the network interface 290 may be capable of employing any of a variety of communications technologies by which parts of the body of the user 100 are used as a communications medium (e.g., for the transmission of electrical signals). In so doing, the network interface 290 may be configured to engage in communications that employ timing, protocols, etc. that are chosen to increase the likelihood of successful reception of network transmissions in spite of various aspects of the body of the user 100, such as neurological and/or muscular activity that may include disruptive electrical signals, and/or changes in electrical resistance of the skin due perspiration and/or other secretions.

Still further, alternatively or additionally, the network interface 290 may be capable of receiving signals emanating from cellular communications towers, satellites, and/or still other sources that are able to be used to determine the current geographic location of the portable device 200. In this way, it may be that such lifestyle characteristics as daily movements among locations by the user 100 (e.g., such locations as their home, their place of work, places at which food may be purchased, places at which physical activities may be engaged in, etc.), as well as travel to still other locations may be collected.

Yet further, alternatively or additionally, the network interface 290 may be capable of transmitting and/or receiving signals on a recurring basis to locate stationary devices 300 that the portable device 200 may be moved into relatively close proximity of as the portable device 200 is carried about. In this way, at a time when body characteristics are to be collected, the user 100 may be prompted to proceed to the such a nearby stationary device 300 to enable its sensor(s) 310 to be used to collected body characteristics in addition to or in lieu of the sensor(s) 210 of the portable device 200.

Turning to FIGS. 2C-D, in addition to FIG. 2A, the control routine 240 may include instructions executable by the processor(s) 250 of the portable device 200 to cause the processor(s) 250 to perform various functions. As previously discussed, among such functions may be providing a user interface (UI) to enable the user 100 to provide information to the system 1000 and/or to enable the system 1000 to present information to the user 100; operating the sensor(s) 210 to collect body characteristics of the user 100; operating the network interface 290 as part of determining the geographic location of the portable device 200; and/or exchanging such information with one or more other devices of the system 1000.

More specifically, in some embodiments, the processor(s) 250 may be caused, by execution of the control routine 240, to monitor the input device(s) 220 for an indication of the portable device 200 being operated by the user 100 to provide information concerning health-related choices to the system 1000. It may be that such an indication includes use of a manual input device 220 of the portable device 200 to manually enter identifiers of various food items that the user 100 is considering eating (e.g., text identifiers assigned to food items at a grocery store or restaurant). Alternatively, it may be that such an indication includes use of a non-manual input device 220 of the portable device to scan barcodes (e.g., one-dimensional barcodes or two-dimensional QR codes) and/or text identifiers assigned to food items in a printed menu at a restaurant, in a displayed menu of a website of a food delivery service, or labels on shelves of a grocery store. As another alternative, it may be that such an indication includes identifiers (whether manually entered, or not) of various physical activities that the user 100 is considering engaging in at a gymnasium (e.g., bar codes or QR codes scanned from a list of available exercise classes in a printed list, or bar codes or QR codes co-located with various pieces of exercise equipment). Where such a non-manual type of entry of identifiers is used, it may be that the processor(s) 250 are further caused by the control routine 240 to interpret such barcodes and/or text to retrieve the identifiers encoded therein.

Upon receiving and/or decoding such identifiers indicating such prospective choices (i.e., health-related choices that are being considered), the processor(s) 250 may then be caused to operate the network interface 290 to transmit the identifiers of those prospective choices, as an instance of the choices data 236, and via the network 999, to another device of the system 1000, such as the reward server 600. As depicted, such an instance of the choices data 236 may be stored within the reward server 600 within a reward record 630 associated with the user 100.

In some embodiments, the processor(s) 250 may also be caused, by execution of the control routine 240, to repeatedly (e.g., at a recurring interval of time) operate the network interface 290 to receive wireless signals from such sources as satellites and/or from cellular communications towers as part of determining the current geographic location of the portable device 200. The processor(s) 250 may build up a record of geographic locations to which the portable device 200 has been moved over time, including the current geographic location of the portable device 200. Then, upon receiving such input identifying prospective choices, the processor(s) 250 may be caused to include indications of such a record of geographic locations in the instance of the choices data 236 that is transmitted to another device of the system 1000 via the network 299.

Also in some embodiments, it may be that the receipt of such input identifying prospective choices through the input device(s) 220 serves as a trigger for the processor(s) 250 to be caused, by execution of the control routine 240, to operate the sensor(s) 210 (whether incorporated directly into the portable device 200, or external and reachable through the PAN 299) to collect (e.g., detect and/or measure) one or more body characteristics of the user 100. In so doing, the processor(s) 250 may be caused to operate the display (as part of using the UI) to provide instructions to the user 100 as to how to position (relative to the body of the user 100) and/or operate the portable device 200 (and/or the sensors 210 associated therewith) to enable such collection to be performed. By way of example, it may be that the user 100 is instructed to put the depicted wrist watch sensor 210w on a wrist to enable the collection of cardiovascular data, to put the depicted belt sensor 210b around their waist to enable the collection of the circumference of their waist, to aim a thermal camera of the portable device 200 at their forehead to enable the collection of their temperature, or to put the depicted shoe sensor 210s on a foot to enable the collection of their weight.

Upon collecting such body characteristics, the processor(s) 250 may then be caused to operate the network interface 290 to transmit indications of such collected body characteristics as an instance of the status data 235, and via the network 999, to another device of the system 1000, such as the status server 500. As depicted, such an instance of the status data 235 may be stored within the status server 500 within a status record 530 associated with user 100.

Again, it should be noted that such collection of body characteristics may also be accompanied by a collection of one or more lifestyle characteristics, and again, this may be dependent upon whether one or more of the sensors 210 are in some way worn or otherwise carried on the body of the user 100 such that collection of body characteristics is allowed to occur over a relatively long period of time (e.g., multiple hours and/or days). By way of example, where a sensor is routinely worn by the user 100 on a wrist or other body portion to collect indications of cardiovascular activity (e.g., pulse, blood pressure, cardiovascular electrical activity, etc.), indications of periods of elevated cardiovascular activity may be stored to serve as indicators of the user 100 having chosen to engaging in physical activity, and/or indications of periods of reduced cardiovascular activity may be stored to serve as indicators of the user 100 having chosen to sleep. Also by way of example, the sensor(s) 210 may include an accelerometer that is able to be used (either by itself, or in conjunction with another sensor 210 monitoring cardiovascular activity) to detect walking and/or running steps of the user 100 as the user 100 moves about.

In such embodiments, it may be that indications of such occurrences of higher and/or lower cardiovascular activity, including the degree and/or duration of each such increase and/or decrease, may be included in the instance of the status data 235 that is transmitted to another device of the system 1000 (e.g., the status server 500) via the network 299. Alternatively or additionally, it may be that indications of the timing and/or duration of such occurrences of higher and/or lower cardiovascular activity may be included as indications of a lifestyle characteristics such as a daily pattern/schedule of activity and/or sleep in the instance of the choices data 236 that is transmitted to another device of the system 1000 (e.g., the reward server 600) via the network. Similarly, such indications of a number of walking and/or running steps of the user 100 per day may be similarly included in that instance of the choices data 236 as further indications of such a daily pattern/schedule.

In some embodiments, in addition to or in lieu of the processor(s) 250 being caused to operate the sensor(s) 210 to collect body characteristics, it may be that the processor(s) 250 are caused to determine whether there is currently a stationary device 300 within a relatively close proximity that may be used to collect body characteristics. Again, it may be that the network interface 290 is employed to locate such a relatively close stationary device 300. If such a stationary device 300 is so located, then the processor(s) 250 may prompt the user 100 (e.g., via the display 280 of the UI) to proceed to that stationary device 300 to use it to collect body characteristics.

As will shortly be explained in greater detail, the servers 500 and/or 600 may perform various analyses using such new instances of the status data 235 and/or such new instances of the choices data 236, respectively. From those analyses, the current level of health of the user 100 may be determined within the status server 500, and/or prospective positive or negative reward(s) may be derived within the reward server 600 for the prospective choice(s) that are indicated as being considered by the user 100.

Upon deriving such prospective rewards, an instance of the reward data 632 conveying indications of those prospective rewards may be transmitted back to the portable device 200, from the reward server 600, and via the network 999. The processor(s) 250 of the portable device 200 may be caused, by execution of the control routine 240, to operate the network interface 290 to receive such an instance of the reward data 632 and store it within the storage 260. The processor(s) 250 may then be caused to operate the display 280 to visually present the prospective rewards to the user 100.

Following the presentation of prospective rewards to the user 100, the processor(s) 250 may be further caused to monitor the input device(s) 220 for an indication of an actual health-related choice ultimately being made by the user 100 from among the prospective choices that were earlier indicated as being considered. Upon receiving such an indication of such an actual choice having been made, the processor(s) 250 may then be caused to operate the network interface 290 to transmit an indication of the actual choice as an instance of the choices data 238, and via the network 999, to another device of the system 1000, such as the reward server 600. As depicted, such an instance of the choices data 238 may be stored within the reward server 600 within the same reward record 630 associated with user 100.

As will shortly be explained in greater detail, the servers 600 and/or 800 may perform various actions to proceed with implementing, as the actual reward, the one of the earlier derived prospective rewards that corresponds to the one of the prospective choices that has become the actual choice. In so doing, an instance of reward data 638 acknowledging and/or confirming the actual choice and/or its corresponding actual reward may be transmitted back to the portable device 200 via the network 999. The processor(s) 250 of the portable device 200 may be caused, by execution of the control routine 240, to operate the network interface 290 to receive that instance of the reward data 638 and store it within the storage 260. The processor(s) 250 may then be caused to operate the display 280 to visually present the acknowledgement and/or confirmation to the user 100.

It should be noted that at least some of these transmissions of such instances of the data 235, 236, 238, 632 and/or 638 may include identifier(s) and/or other indication(s) of the identity of the user 100 to enable various ones of the devices of the system 1000 to properly associated these instances of data with other information concerning the user 100. It should also be noted that, as part of preserving the privacy of the user 100, at least some of these transmissions of such data may be encrypted and/or protected by various other security measures that condition the performance of transmissions on the verification of the particular device(s) to which they may be directed. Additionally, it may be that at least some of these transmissions include identifier(s) and/or other indication(s) of the current location of the portable device 200, which may indicate where the user 100 is currently located while considering prospective health-related choices and/or making an actual health-related choice.

Turning to FIG. 2B, each of the one or more stationary devices 300 may include one or more of sensor(s) 310, processor(s) 350, a storage 360, and/or a network interface 390 to couple the stationary device 300 to the network(s) 399 and/or 999. Within each stationary device 300, the processor(s) 350 may be communicatively coupled to others of these components, via one or more buses and/or other form(s) of interconnect therein, to enable the exchange of executable instructions and/or data thereamong via the exchange of electrical, optical, magnetic and/or other transmissions. The storage 360 may store an instance of status data 335 associated with a user of the system 1000 (e.g., the user 100). The storage 360 may also store a control routine 340.

The one or more sensors 310 may each be any of a variety of types of sensor capable of collecting (e.g., detecting and/or measuring) any of a variety of body characteristics of users of the system 1000 (e.g., the user 100). Again, such body characteristics may include, and are not limited to, weight, waist circumference and/or another body dimension, blood pressure, heart rate, electrical cardiovascular activity, other aspects of cardiovascular activity, pulmonary activity, gastrointestinal activity, biochemical changes, etc. Following such use of the one or more sensors 310 to collect body characteristics of a user of the system 1000, indications of those one or more characteristics may be stored as the depicted instance of the status data 335.

It is envisioned that some body characteristics are able to be collected (e.g., detected and/or measured) using sensors that are cost effectively portable enough to be incorporated into and/or otherwise accompany portable devices such as the portable device 200 (e.g., the sensors 210), while in contrast, other body characteristics must be collected using sensors that are not so portable (e.g., the sensors 310). Thus, it may be that each of the one or more stationary devices 300 serves to make such less portable sensors available for use in collecting body characteristics of users of the system 1000. Such less portable sensors 310 may include, and are not limited to, a weight measuring sensor with a pad atop which a user is to stand, an inflatable cuff for use around an arm to measure blood pressure, etc. In view of this less portable nature of such sensors, it may be the sensors 310 of the one or more stationary devices 300 are at least less able to collect body characteristics in a continuous manner and/or at recurring intervals over period of time (e.g., hours and/or days).

In embodiments in which the weight of a user of the system 1000 (e.g., the user 100) is a body characteristic that is collected (e.g., measured), it may be that the stationary device 300 takes the form of a stationary scale incorporating a strain gauge (or other weight measuring component) that serves as a sensor 310. Such an embodiment of the stationary device 300 may be installed at any of a variety of locations at a restaurant, grocery store, gymnasium, ball court, playing field, entry way of a hiking trail, etc. for the purpose of weighing users of the system 1000 who may frequent such places, including the user 100. By way of example, it may be that such an embodiment of the stationary device 300 is positioned within or near a restroom to allow the weights of users of the system 1000 to be relatively discretely collected in a manner intended to minimize public embarrassment. Alternatively or additionally, it may be that such an embodiment of the stationary device 300 is installed at the homes of users of the system 1000, including the user 100, to allow for such discrete collection of their weights.

In embodiments in which the cardiovascular activity of a user of the system 1000 (e.g., the user 100) is a body characteristic that is collected, it may be that the stationary device 300 takes the form of a kiosk incorporating a blood pressure cuff (or other blood pressure measuring component) that serves as a sensor 310. Again, such an embodiment of the stationary device 300 may be installed at any of a variety of stores, restaurants, hotel lobbies, etc. that may be frequented by users of the system 1000, including at discrete locations within such establishments to minimize public embarrassment. Alternatively or additionally, in other embodiments in which the cardiovascular activity of a user of the system 1000 is a body characteristic that is collected, it may be that the stationary device 300 takes the form of a relatively small device providing electrodes (or other form of EKG measuring component) that serve as a sensor 310 to detect and/or measure cardiovascular electrical activity.

It should again be noted that, in some embodiments, the stationary device 300 may be equipped with a variety of different sensors 310. Thus, it may be that such an embodiment of the stationary device 300 is able to be used to collect a combination of body characteristics of a user of the system 1000 (e.g., the user 100), such as a combination of weight and one or more aspects of cardiovascular activity.

Not unlike the processor(s) 250 of the portable device 200, the processor(s) 350 of the stationary device 300 may each be any of a wide variety of types of processor that are configured to perform instruction-based processing that entails the execution of sequences of instructions, and may each incorporate any of a variety of features to enhance speed and/or efficiency of processing operations. Not unlike the storage 260, the storage 360 may be based on any of a variety of storage technologies that provide relatively high speeds of access, but which require the continuous provision of electric power to retain any data and/or routines stored therein. Somewhat similarly to the network interface 290, the network interface 390 may at least be capable of employing any of a variety of wireless communications technologies that may be associated with the networks 399 and/or 999. Alternatively or additionally, the network interface 390 may at least be capable of employing any of a variety of cabling-based communications technologies by which electrical and/or optical signals may be used in to exchange information through any of a variety of electrical and/or optical cabling.

Turning to FIG. 2C, in addition to FIG. 2B, the control routine 340 may include instructions executable by the processor(s) 350 to cause the processor(s) 350 of the stationary device 300 to perform various functions. As previously discussed, among such functions may be operating the sensor(s) 310 to collect body characteristics of a user of the system 1000 (e.g., the user 100), and/or exchanging such information with one or more other devices of the system 1000. More specifically, in some embodiments, the processor(s) 350 may be caused, by execution of the control routine 340, to operate the network interface 390 to monitor for the receipt of a request to use the one or more sensors 310 to collect body characteristics of a user of the system 1000.

By way of example, such a request may be received from the portable device 200 of the user 100 via the depicted LAN 399. As will be familiar to those skilled in the art, prior to the receipt of such a request via the LAN 399, it may be necessary for the portable device 200 and the stationary device 300 to cooperate to establish at least a portion of the LAN 399 that provides a path for communications therebetween. Such cooperation may be the through the use of any of a variety of widely known and used protocols for establishing wireless communications between such devices, including and not limited to, any of a variety of pairing protocols. In some embodiments, it may be that establishing wireless communications between the depicted devices 200 and 300 includes operation of a non-manual input device 220 of the portable device 200 to capture an image of a marking (e.g., a barcode, human-readable text, etc.) that is carried by the stationary device 300 on a surface thereof, carried on signage posted at or near the stationary device 300, or that is otherwise visually presented by the stationary device 300 (e.g., visually presented on a display thereof). Such a marking may provide an identifier and/or other information associated with the stationary device 300 that enables such wireless communications to be established.

Regardless of the exact manner in which the stationary device 300 is requested or otherwise triggered to collect one or more body characteristics of the user 100, upon being so requested or triggered, the processor(s) 350 may be caused, by execution of the control routine 340, to operate the one or more sensors 310 incorporated into (or otherwise associated with) the stationary device 300 to so collect such body characteristics. Upon collecting such body characteristics, the processor(s) 350 may then be caused to operate the network interface 390 to transmit indications of those body characteristics as the depicted instance of the status data 335 to another device of the system 1000, such as the status server 500, and via the network 999. In some embodiments, the transmission of such an instance of the status data 335 may be more directly to the status server 500 via the network 999. In other embodiments, the transmission of such status data may be more indirectly, such as through the LAN 399 and the portable device 200, before being relayed onward to the status server 500 via the network 999. As depicted, such an instance of the status data 335 may be stored within the status server 500 within a status record 530 associated with user 100.

Regardless of the exact manner in which such instances of status data 335 are conveyed to the status server 500 (and/or to another device of the system 1000), it should again be noted that at least some of these transmissions may include identifier(s) and/or other indication(s) of the identity of the user 100. It should also again be noted that at least some of these transmissions may be encrypted and/or protected by various other security measures. Additionally, it may be that at least some of these transmissions include identifier(s) and/or other indication(s) of the location of the stationary device 300.

Turning to FIG. 2C, the status server 500 may include one or more of processor(s) 550, a storage 560, and/or a network interface 590 to couple the status server 500 to the network 999. The processor(s) 550 may be communicatively coupled to others of these components, via one or more buses and/or other form(s) of interconnect therein, to enable the exchange of executable instructions and/or data thereamong via the exchange of electrical, optical, magnetic and/or other transmissions. The storage 560 may store a set of the status records 530 and/or a control routine 540. Each status record 530 may correspond to one of multiple users of the system 1000 (e.g., the user 100). Also, each status record 530 may store multiple instances of the status data 235 and/or 335, an instance of the health data 536, and/or a health model 570 selected for the user with which that status record 530 is associated.

Not unlike the processor(s) 250 of the portable device 200 and/or the processor(s) 350 of the stationary device 300, the processor(s) 550 of the status server 500 may each be any of a wide variety of types of processor that are configured to perform instruction-based processing that entails the execution of sequences of instructions, and may each incorporate any of a variety of features to enhance speed and/or efficiency of processing operations. Not unlike the storages 260 and/or 360, the storage 560 may be based on any of a variety of storage technologies that provide relatively high speeds of access, but which require the continuous provision of electric power to retain any data and/or routines stored therein. Somewhat similarly to the network interfaces 290 and/or 390, the network interface 590 may at least be capable of employing any of a variety of wireless and/or cabling-based communications technologies that may be associated with the network 999.

The control routine 540 may include instructions executable by the processor(s) 550 of the status server 500 to cause the processor(s) 550 to perform various functions. As previously discussed, among such functions may be receiving instances of the status data 235 and/or 335 for each of multiple users of the system 1000 (e.g., the user 100); deriving levels of health for each such user; and/or providing instances of health data 536 conveying indications of such levels of health to other device(s) of the system 1000.

More specifically, in some embodiments, the processor(s) 550 may be caused, by execution of the control routine 540, to maintain the set of status records 530. In some embodiments, the set of status records 530 may be organized into any of a variety of types of database or other organizational system that enables each status record 530 to be individually accessed. Each status record 530 may contain any of a wide variety of types of information concerning the health of its associated user of the system 1000 (including a single one of the status records 530 associated with the user 100).

The processor(s) 550 may be caused, by execution of the control routine 540, to operate the network interface 590 to at least monitor for the receipt of instances of the status data 235 and/or 335 for each user of multiple users of the system 1000, including the user 100. However, it should be noted that, in some embodiments, the processor(s) 550 may be caused, by execution of the control routine 540, to operate the network interface 590 to transmit, to the portable devices 200 of users of the system 1000 via the network 999, requests to provide body characteristics of those users, thus causing new instances of the status data 235 and/or 335 for multiple users of the system 1000 to be provided to the status server 500. More precisely, within each such portable device 200, the receipt of such a request may trigger the presentation of an audio and/or visual prompt to the corresponding user to interact with the portable device 200, one or more sensors 210 associated therewith, and/or a stationary device 300 to collect one or more body characteristics, such as their weight, waist circumference, blood pressure, heart-related electrical activity, pulmonary activity, etc.

For each user of the system 1000, the processor(s) 550 may be caused to transmit such a request to the portable device 200 of that user in response to the elapsing of a predetermined period of time since the last instance of the status data 235 and/or 335 for that user was received by the status server 500. Additionally, such a request may specify the use of a particular stationary device 300 that may be determined by the processor(s) 550 to be within a relatively close proximity to that portable device 200. As previously discussed, it may be that an indication of the current geographic location of that portable device may be included in instances of the status data 235 that may be received by the status server 500 therefrom. Thus, the status server 500 may employ such an indication of location to identify a stationary device 300 that is within such a relatively close proximity, and then transmit a request to that portable device 200 to prompt that user to proceed to that stationary device 300 to enable the collection of body characteristics thereby. Alternatively or additionally, and as previously discussed, it may be that the portable device 200 employs exchanges of wireless signals to, itself, identify a stationary device 300 that is within such a relatively close proximity.

Regardless of whether instance(s) of status data 235 and/or 335 are provided in response to such a request being transmitted to a portable device 200, one response to the receipt of an instance of the status data 235 and/or 335 for a particular user may be that the received instance is stored within a status record 530 for that particular user. As previously discussed, each instance of the status data 235 and/or 335 may incorporate, and/or be otherwise accompanied by, an identifier of a user of the system 1000 with which it is associated (e.g., the user 100). As also previously discussed, such identifiers may be used to match a received instance of the status data 235 and/or 335 that is associated with a particular user to the status record 530 that is also associated with that particular user.

Regardless of the exact details of storage of received instances of the status data 235 and/or 335, execution of the control routine 540 may also cause the processor(s) 550 to respond to the receipt of instance(s) of the status data 235 and/or 335 for a particular user (e.g., the user 100) by using the one or more body characteristics indicated therein to derive a current level of health of that particular user, which may then be stored as the health data 536. Indeed, in some embodiments, it may be that each newly derived level of health (which would be an update to the current level of health at that time) may be stored within the corresponding status record 530 as a new instance of the health data 536. In some embodiments, it may be that a predetermined quantity of the most recent instances of the health data 536 may be so stored to provide a record thereof (e.g., the 10 most recent instances; or whatever number of instances fall within the last week, the last month, the last three, months, the last 365 days, etc.). Regardless of the exact details of such storage, the processor(s) 550 may then operate the network interface 590 to transmit an instance of the health data 536 indicating the current level of health of the particular user to the reward server 600 via the network 999.

As previously discussed, the current level of health of a user that is conveyed in the most recent instance of the health data 536 associated with that user may include one or more data values that may be based on any of a wide variety of health statistics and/or rating systems. In such embodiments, such health statistics and/or rating systems may be based on any of a wide variety of various body characteristics, including and not limited to, age, gender, height, race/ethnicity, history of pregnancy (in the case of women), presence and/or absence of particular genes and/or combinations of genes, etc. As will be familiar to those skilled in the art, the array of factors that determine susceptibility of a person to particular medical conditions can be quite extensive.

By way of example, and as will be familiar to those skilled in the art, the calculation performed to derive BMI (body mass index) begins with selecting a growth chart from among multiple growth charts based on at least the age and gender of a person. Then a calculation is performed using the selected growth chart in combination with the height and weight of that person. The result of that calculation is a number within a range of numbers that provides an indication of level of obesity. However, in more recent years, concerns have been raised about the need to provide different growth charts for people of different races/ethnicities and/or who live in different cultures to take into account differences in genetics, physical activity, and/or diet that such factors may cause.

In some embodiments, to accommodate such approaches to deriving such a current level of health of a user, it may be that a set of health models 570 are created, and in a manner not unlike the selection of a growth chart for BMI, one of such health models 570 is selected for each user of the system 1000 based on one or more factors associated with that user. Such factors may include information collected during interactions between each user of the system 1000 and various medical professionals, such as medical diagnoses made, medical tests that are performed and/or their results, medications that are prescribed, medical procedures that are performed, etc. This may be in recognition of the potential of an interaction with a medical professional to reveal more detail about a user's health than may be possible to obtain from the recurring use of the aforedescribed sensors 210 and/or 310. Following the selection of a particular health model 570 for a particular user, various body characteristics conveyed in instances of the status data 235 and/or 335 for that particular user may be used with that particular model 570 to derive the current level of health for that particular user that is then provided to the reward server 600 as an instance of the health data 536.

It should be noted that, in some of such embodiments, the selection of a health model 570 for each user may be re-evaluated on a recurring basis. By way of example, it may be that the selection of a health model 570 for each user occurs on their birthday to at least account for the corresponding increase in age (e.g., for embodiments in which age is a factor, such as for embodiments that employ a BMI calculation). Alternatively or additionally, it may be that the selection of a health model 570 for each user is triggered by various medical events that may involve interactions with medical professionals, (e.g., a physical exam by a doctor, a new or changed medical diagnosis, a new or changed prescription of medicine, a new medical test and/or the results thereof, a new medical procedure, etc.). Again, this may be in recognition of the potential of an interaction with a medical professional to reveal more detail about a user's health than may be possible to obtain from the recurring use of the aforedescribed sensors 210 and/or 310. Also alternatively or additionally, it may be that a change in a quantifiable body characteristic such as blood pressure, heart rate, weight, waist circumference (or other body dimension), prescribed dosage of a medication, level of blood oxygenation, level of an amount of a blood component (e.g., red cell or white cell count), etc. where the change exceeds a predetermined threshold of change in a body characteristic (e.g., a threshold percentage of change).

In some embodiments in which health model(s) 570 are used, it may be that one or more health models 570 are able to be adjusted for a particular user to take into account one or more relatively unique characteristics of a particular user. As will be familiar to those skilled in the art, approaches to evaluating the current medical condition of a person tend to be based on observations made across relatively wide cross-sections of a population, which typically causes such evaluation approaches to be applicable to people having “typical” characteristics. However, as will also be familiar to those skilled in the art, there are nearly always a subset of people who demonstrate one or more “atypical” characteristics, including and not limited, to atypical blood chemistries, atypical reactions to various foods and/or medications, atypical physical proportions, various physical and/or mental handicaps, various genetic defects, lasting physical and/or mental effects of trauma and/or disease experienced during their lives, etc.

More specifically, it may be during physical examinations and/or other medical procedures that such atypical characteristics may be revealed (e.g., as part of a diagnosis), and indications of such atypical characteristics may be added to the status record 530 for a particular user of the system 1000. It may be that, as a result of the addition such information, a different health model 570 may need to be selected for a particular user, and/or the health model 570 that has been selected needs to be adjusted for that particular user. Such a selection of a different health model 570 and/or such an adjustment of a selected health model 570 may enable the derivation of a level of health for that particular user that is more accurate than would be possible if such actions were not taken to account for such atypical characteristics. By way of example, it may be that the user 100 is a double amputee such that their weight, with and/or without a pair of prosthetic legs, would tend to cause the derived level of health to be indicative of being unhealthy, even though they may actually be healthy. By way of another example, it may be that the user 100 suffers from a severe allergy to particular foods such that their diet is necessarily atypical in terms of how much of one or more food alternatives they must eat to get proper nutrition.

In other words, such information provided by medical professionals may provide “ground truth” data by which the corresponding health model 570 may be calibrated to be more accurate. In some of such embodiments, a medical professional may provide input indicating that, at a particular time during a particular medical visit, the user 100 is at a particular level of health, and it may be that, in executing the control routine 540, the processor(s) 550 are able to use that information to recalibrate the corresponding health model 570 to cause body characteristics provided by that medical professional to become correlated to the user 100 being at that particular level of health. Stated differently, information provided by medical professionals during an in-person medical interaction may provide a set of body characteristics that serve as at least an aid to defining what is healthy for the user 100.

Indeed, in some embodiments, it may be that indications of such information as might be collected from interactions with medical professionals may be included in the instances of the health data 536 that are conveyed from the status server 500 to the reward server 600. As will shortly be explained, some of such information may be employed as lifestyle characteristics relevant to deriving rewards.

Turning to FIG. 2D, the record server 600 may include one or more of processor(s) 650, a storage 660, and/or a network interface 690 to couple the record server 600 to the network 999. The processor(s) 650 may be communicatively coupled to others of these components, via one or more buses and/or other form(s) of interconnect therein, to enable the exchange of executable instructions and/or data thereamong via the exchange of electrical, optical, magnetic and/or other transmissions. The storage 660 may store a set of the reward records 630, a set of choice records 636 and/or a control routine 640. Each reward record 630 may correspond to one of multiple users of the system 1000 (e.g., the user 100). Also, each reward record 630 may store multiple instances of the health data 536; multiple instances of the choices data 236, 238 and/or 838; multiple instances of the reward data 632 and/or 638; and/or a reward model 670 that are associated with the user with which the reward record 630 is associated.

Not unlike the processors 250, 350 and/or 550, the processor(s) 650 may each be any of a wide variety of types of processor that are configured to perform instruction-based processing that entails the execution of sequences of instructions, and may each incorporate any of a variety of features to enhance speed and/or efficiency of processing operations. Not unlike the storages 260, 360 and/or 560, the storage 660 may be based on any of a variety of storage technologies that provide relatively high speeds of access, but which require the continuous provision of electric power to retain any data and/or routines stored therein. Somewhat similarly to the network interfaces 290, 390 and/or 590, the network interface 690 may at least be capable of employing any of a variety of wireless and/or cabling-based communications technologies that may be associated with the network 999.

The control routine 640 may include instructions executable by the processor(s) 650 of the reward server 600 to cause the processor(s) 650 to perform various functions. As previously discussed, among such functions may be receiving instances of the health data 536, along with instances of the choices data 236, 238 and/or 838 for each of multiple users of the system 1000; deriving rewards for prospective choices and/or actual choices for each such user; and/or providing instances of the reward data 632 and/or 638 conveying indications of corresponding prospective rewards and/or actual awards to other device(s) of the system 1000.

More specifically, in some embodiments, the processor(s) 650 may be caused, by execution of the control routine 640, to maintain the set of reward records 630. Not unlike the status records 530, the set of reward records 630 may be organized into any of a variety of types of database or other organizational system that enables each reward record 630 to be individually accessed. Each reward record 630 may contain any of a wide variety of types of information concerning rewards for its associated user of the system 1000.

The processor(s) 650 may be caused, by execution of the control routine 640, to operate the network interface 690 to at least monitor for the receipt of instances of the health data 536 and/or instances of the choices data 236, 238 and/or 838 for each user of multiple users of the system 1000, including the user 100. One response to the receipt of an instance of the health data 536, or an instance of the choices data 236, 238 or 838 for a particular user may be that the received instance is stored within a reward record 630 for that particular user. As previously discussed, each instance of the health data 536, and/or of the choices data 236, 238 or 838 may incorporate, and/or be otherwise accompanied by, an identifier of a user of the system 1000 with which it is associated (e.g., the user 100). As also previously discussed, such identifiers may be used to match a received instance of the health data 536, and/or of the choices data 236, 238 or 838 that is associated with a particular user to the reward record 630 that is also associated with that particular user.

Regardless of the exact details of storage of received instances of the health data 536, and/or of the choices data 236, 238 and/or 838, execution of the control routine 640 may also cause the processor(s) 650 to respond to the receipt of an instance of the choices data 236 indicating one or more prospective choices being considered by a particular user (e.g., the user 100) by using a combination of at least the received instance of the choices data 236 and at least the most recent instance of the health data 536 to derive a prospective reward for each prospective choice indicated in the received instance of choices data 236. Where the most recent instance of the health data 536 is older than a predetermined threshold age, the processor(s) 650 may be caused to operate the network interface 690 to transmit, via the network 999, a request either directly to the portable device 200 of the corresponding user to prompt that user to provide one or more body characteristics (e.g., a waist or weight measurement, a blood pressure reading, EKG data, etc.), or to the status server 500 to cause the status server 500 to transmit such a request to that portable device 200 to so prompt that user. Regardless of the exact manner in which that user is so prompted, and as previously discussed, upon receiving an instance of status data 235 and/or 335 providing such body characteristics, the status server 500 may then generate a new level of health for that user, and may provide an indication of that new level to the reward server 600 in a new instance of the health data 536.

Regardless of whether the most recent instance of the health data 536 that is already stored within the reward server 600 is used, or a new instance of the health data 536 that is caused to be received by the reward server 600 is used, a new instance of the reward data 632 may be generated to include an indication of each prospective reward derived for the one or more prospective choices that are indicated in the received instance of the choices data 236 as being considered. The processor(s) 650 may then operate the network interface 690 to transmit that instance of the reward data 632, via the network 999, to the portable device 200 associated with that user to enable that portable device 200 to present those one or more prospective rewards to that user. The processor(s) 650 may then operate the network interface 690 to monitor for the receipt of an indication of an actual choice that is ultimately made by that user from among those one or more prospective choices.

Presuming that the user associated with that portable device 200 does ultimately make an actual choice from among those one or more prospective choices, the reward server 600 may receive, from that portable device 200, an instance of the choices data 238 identifying that actual choice that was ultimately made by that user. In response to receiving that instance of the choices data 238, the processor(s) 650 may be caused to generate an instance of the reward data 638 that specifies the actual reward that is associated with the actual choice ultimately made by that user, and that is the actual reward that is to be implemented. The processor(s) 650 may then operate the network interface 690 to transmit that instance of the reward data 638 to the account server 800 and/or to that same portable device 200 via the network 999. In some embodiments, it may be that the transmission of the instance of the reward data 638 to the account server 800 is part of a “handshake” protocol through the network 999 between the reward server 600 and the account server 800 in which the instance of the reward data 638 provides an indication of the actual reward to provide to that user, and the account server 800 transmits a confirmation back to the reward server 600 of receipt of that instance and/or of completion of implementing that actual reward. More specifically, upon implementing that actual reward, the reward server 600 may transmit the instance of the reward data 638 to the portable device 200 as the confirmation that the actual reward has indeed been implemented.

It should be noted, however, that in some embodiments, it may be possible for a user of the system 1000 (e.g., the user 100) to make an actual choice without the reward server 600 being earlier provided with an indication of prospective choice(s) being considered. It may also be possible for a user of the system 1000 to make an actual choice that is not among prospective choices that were earlier provided to the reward server 600. Stated differently, instead of the reward server 600 first receiving an instance of the choices data 236 indicating one or more prospective health-related choices that are being considered by a user, and from which an actual choice is made by that user, the reward server 600 may receive an instance of the choices data 238 that indicates an actual health-related choice that has ultimately been made by that user without having been earlier presented as a prospective choice such that a corresponding prospective reward would have been derived.

As previously discussed, it may be that the prospective choices that are being considered and/or the actual choices that are ultimately made by users of the system 1000 may each be indicated in instances of the choices data 236, 238 and/or 838 using identifiers. At least a subset of these identifiers may each identify a particular food choice (e.g., a meal offered at a restaurant, a food ingredient offered at a grocery store, etc.). Alternatively or additionally, at least a subset of these identifiers may each identify a particular physical activity and/or a duration of a particular physical activity. Also alternatively or additionally, at least a subset of these identifiers may each identify a particular type of rest with a relatively significant duration, such as sleeping multiple hours, sitting for one or more hours to watch a movie, driving for one or more hours, etc. In some embodiments, at least some of these identifiers may be divided into portions that separately identify particular vendors (e.g., particular stores, gymnasiums, parks, restaurants, and/or chains thereof), as well as particular foods, physical activities, types of rest, etc.

Regardless of the manner in which the identifiers of health-related choices may be generated, as previously discussed, each choice record 636 of the set of choice records 636 may correlate an identifier of a single health-related choice to details concerning that choice. Where a particular health-related choice is an item of food or an entire meal, the corresponding choice record 636 may describe such aspects of that choice as amounts of nutrients, such as vitamins, minerals, fats, cholesterols, sugars, calories, recommended daily amount(s), etc. Where a particular health-related choice is a physical activity of a particular duration and/or performed at a particular location (e.g., at a particular park, trail, gymnasium, etc.), the corresponding choice record 636 may describe such aspects as one or more amounts associated with expending energy, such as an amount of joules of energy; an amount of calories burned; fat, sugars, and/or cholesterols expended; a recommended number of hours per week; etc. In such embodiments, it may be that the type and/or amount of an award derived for a choice may be based on such details. By way of example, a relatively positive reward may be derived for a food-related choice that would provide numerous helpful nutrients and a relatively low intake of fats, cholesterols and/or calories; while a less positive or relatively negative reward may be derived for a food-related choice that would provide relatively few helpful nutrients and/or a relatively high intake of fats, cholesterols and/or calories.

As will be familiar to those skilled in the art, the health-related choices made by each person are affected by various lifestyle characteristics of their daily lives, including various aspects of culture, upbringing and/or other life experiences. By way of example, such lifestyle characteristics as culture, religion, marital status and/or parental status, where a person lives, where a person works, what industry a person works in and/or what position they hold therein, etc. may influence their work hours and/or what holidays they celebrate. By way of another example, such lifestyle characteristics as whether a person works remotely from their home, works at a distinct worksite, and/or travels frequently while working, may also influence their work hours, etc.

For example, a person with such lifestyle characteristics as shorter work hours, fewer working days per week and/or a greater number of holidays away from work each year may be able to put in a more concentrated effort on improving their food, physical activity and/or resting choices. Such a person may be more easily encouraged to improve their choices with smaller rewards, such as discounts associated with better choices (e.g., encourage them to drive a few miles further to restaurants and/or stores with better quality food, and/or to spend more time at a gym). In contrast, a person with such lifestyle characteristics as longer work hours, more working days per week and/or a lesser number of holidays away from work each year may have less flexibility in making healthier choices. Such a person may need to be encouraged with incentives that better fit a more limited schedule and/or that convince them to at least not make unfavorable choices as often during their more limited time off (e.g., convince them not to use drinking and/or eating excessively to “let off steam” during their limited time off, etc.).

Also for example, a person with such lifestyle characteristics as having a family (e.g., a spouse and one or more children) may be more likely to plan daily activities such as meals and/or types of physical activity such that they may be more easily encouraged to modify such planning towards healthier choices. In contrast, a person with such lifestyle characteristics as being single with no children (or at least no children that they are raising) may live more spontaneously such that they are less likely to plan daily activities, and such that they may be more easily tempted to make less healthy choices and find it harder to stick with making healthier choices.

To take into account such potentially wide variations in lifestyle characteristics among users of the system 1000, it may be that a set of reward models 670 are used. In such embodiments, it may be that one or more of such lifestyle characteristics as occupation, wealth, age, ethnicity/race, religion, place of birth, citizenship, living and/or work location(s), culturally-related diet, regionally-related lifespan, rating(s) of locally provided healthcare systems, etc., are used to select an appropriate reward model 670 for each user of the system 1000 (including the user 100). It may be that the selection of a particular reward model 670 dictates what financial and/or other type(s) of reward are among those that will be used to encourage better choices. By way of example, it may be that some users are best encouraged with offers of discounts for better choices, while other users are best encouraged with a point system that entails the addition or subtraction of points based on choices that leads to such rewards as more or fewer vacation days and/or a higher or lower tier of “prizes” that they could win. By way of another example, it may be that a sufficient improvement in choices and/or in an associated level of health leads to opportunities to take a break of one or more days from having to interact with the system 1000.

As one or more lifestyle characteristics of a particular user change (e.g., growing older, changing jobs, changing income, retiring, getting married and/or divorced, child birth and/or child becoming an adult, etc.), the selection of a reward model 670 for that particular user may be updated to one that has been found to be better correlated to those changes. More specifically, in some embodiments, the processor(s) 650 may be caused to re-evaluate which reward model 670 is associated with a particular user of the system 1000 in response to a change in such quantifiable lifestyle characteristics as salary, commute distance, work hours, hours of physical activity and/or sleep each day (as may be indicated in instances of the choices data 236 and/or 238), etc. that is of a degree that exceeds a predetermined threshold of change in a lifestyle characteristic (e.g., a threshold percentage of change). In some embodiments, the processor(s) 650 may be caused to re-evaluate which reward model 670 is associated with a particular user of the system 1000 in response to a change in such non-quantifiable lifestyle characteristics as being employed or unemployed, being married or not married, suffering a severe medical condition (as may be indicated in a received instance of the health data 536) such as a heart attack or the loss of a limb, etc.

Alternatively or additionally, one or more of the reward models 670 may be altered over time through machine learning in response to circumstances in which the behavior of multiple users associated with a particular reward model 670 changes over time. This may be used as an approach to accommodating societal changes that inevitably happen over time that change the behaviors of various groups of users (e.g., changes in the economy of a society, changes in the fortunes of a particular industry, changes caused by such society-wide situations as a pandemic, etc.).

Referring briefly to FIGS. 2A-B, in addition to FIG. 2D, it should be noted that a subset of lifestyle-related and/or choices-related information may be collected by the sensors 210 and/or 310 associated with the devices 200 and/or 300, respectively. More specifically, it may be that information indicative of some degree of physical activity (e.g., a quantity of steps taken per hour or per day, an amount of hours of physical inactivity or rest per day, etc.) may be collected by the sensors 210 and/or 310 along with body characteristics. In such embodiments, it may be that such information indicative of physical activity and/or rest is included as indications of actual choices of physical activity that are transmitted to the reward server 600 as instances of the choices data 238.

Turning to FIG. 2E, the account server 800 may include one or more of processor(s) 850, a storage 860, and/or a network interface 890 to couple the account server 800 to the network 999. The processor(s) 850 may be communicatively coupled to others of these components, via one or more buses and/or other form(s) of interconnect therein, to enable the exchange of executable instructions and/or data thereamong via the exchange of electrical, optical, magnetic and/or other transmissions. The storage 860 may store a set of the account records 830 and/or a control routine 840. Each account record 830 may correspond to one of multiple users of the system 1000 (e.g., the user 100). Also, each account record 830 may store multiple instances of the choices data 838; and/or multiple instances of the reward data 638. Additionally, each account record may store an indication of an amount of money associated with its corresponding user (e.g., an amount of money able to be spent by the corresponding user, an amount of credit available for use by the corresponding user, etc.). Alternatively or additionally, each account record may store an indication of a quantity of points or other form of token able to be traded and/or otherwise used by the corresponding user to obtain a form of prize or other reward item.

Not unlike the processors 250, 350, 550 and/or 650, the processor(s) 850 may each be any of a wide variety of types of processor that are configured to perform instruction-based processing that entails the execution of sequences of instructions, and may each incorporate any of a variety of features to enhance speed and/or efficiency of processing operations. Not unlike the storages 260, 360 560 and/or 660, the storage 860 may be based on any of a variety of storage technologies that provide relatively high speeds of access, but which require the continuous provision of electric power to retain any data and/or routines stored therein. Somewhat similarly to the network interfaces 290, 390, 590 and/or 690, the network interface 890 may at least be capable of employing any of a variety of wireless and/or cabling-based communications technologies that may be associated with the network 999.

The control routine 840 may include instructions executable by the processor(s) 850 of the account server 800 to cause the processor(s) 850 to perform various functions. As previously discussed, among such functions may be receiving instances of the reward data 638; implementing the actual reward indicated in each received instance of the reward data 638; and/or generating instances of the choices data 838 to specify an actual choice ultimately made by a user of the system 1000 through use of the card 900.

More specifically, in some embodiments, the processor(s) 850 may be caused, by execution of the control routine 840, to maintain the set of account records 830. Not unlike the status records 530 and the reward records 630, the set of account records 830 may be organized into any of a variety of types of database or other organizational system that enables each account record 830 to be individually accessed. Each account record 830 may contain any of a wide variety of types of information concerning actual rewards for its associated user of the system 1000.

The processor(s) 850 may be caused, by execution of the control routine 840, to operate the network interface 890 to at least monitor for the receipt of instances of the reward data 638 for each user of multiple users of the system 1000, including the user 100. One response to the receipt of an instance of the reward data 638 for a particular user may be that the received instance is stored within an account record 830 for that particular user. As previously discussed, each instance of the reward data 638 may incorporate, and/or be otherwise accompanied by, an identifier of a user of the system 1000 with which it is associated (e.g., the user 100). As also previously discussed, such identifiers may be used to match a received instance of the reward data 638 that is associated with a particular user to the account record 830 that is also associated with that particular user.

Regardless of the exact details of storage of received instances of the reward data 638, execution of the control routine 840 may also cause the processor(s) 850 to respond to the receipt of an instance of the reward data 638 indicating an actual reward to be implemented for a particular user (e.g., the user 100) by proceeding to so implement that actual reward. By way of example, where the account record 830 stores an indication of an amount of money or an amount of credit able to be accessed and/or used by the particular user, it may be that a positive actual reward that is so implemented is an increase in that amount of money or amount of credit, and/or it may be that a negative actual reward that is so implemented is a decrease thereof. Similarly, and where the account record 830 stores an indication of a quantity of points or some other form of token able to be used to obtain a form of prize, etc., a positive actual reward may similarly be an increase in that quantity, and/or a negative actual reward may similarly be a decrease in that quantity. By way of example, where the account record 830 stores an indication of a quantity of hours and/or days of a break that the particular user has earned from having to interact with the system 1000, a positive actual reward may similarly be an increase in that quantity, and/or a negative actual reward may similarly be a decrease in that quantity.

As previously discussed, it may be that, following implementation of an actual reward that is indicated in a received instance of the reward data 638, the processor(s) 850 may be additionally caused to transmit, back to the reward server 600 via the network 999, an indication of confirmation that the actual reward so indicated has indeed been implemented. Again, in response to the receipt of such a confirmation, the reward server 600 may additionally transmit the reward data 638, via the network 999, to the portable device 200 of the corresponding user of the system 1000 to enable that portable device 200 to provide that user with an indication of implementation of that actual reward.

As also previously discussed, in some embodiments, it may be that the implementation of actual rewards for a particular user of the system 1000 (e.g., the user 100) is associated with a credit or debit card 900. More specifically, where actual rewards involve an amount of money and/or credit, the credit or debit card 900 may provide a mechanism by which the particular user is able to avail themselves of such money and/or credit provided to them as such actual reward(s).

Alternatively or additionally, and as also previously discussed, in some embodiments, it may be that the act of using the credit or debit card 900 by a particular user of the system 1000 is relied upon to provide the system 1000 with an indication of an actual health-related choice that is made by the particular user. More specifically, by using the card 900 to actually implement such a choice with an amount of money and/or credit, the resulting transaction involving the account server 800 and a particular account record 830 serves to provide the system 1000 with such an indication. In such an embodiment, the processor(s) 850 of the account server 800 may be caused, by execution of the control routine 840 to respond to such an indication by generating an instance of the choices data 838 to include an indication of that actual choice as having been made by the particular user. The processor(s) 850 may then be caused to operate the network interface 890 to transmit that instance of the choices data 838, via the network 999, to the reward server 600 to cause the reward server 600 to derive a corresponding actual reward to be implemented by the account server 800. In response, the reward server 600 may derive such an actual reward, may generate an instance of the reward data 638 that includes an indication of that actual reward, and may transmit that instance of the reward data 638 back to the account server 800 via the network 999. As previously discussed, in response to receiving that instance of the reward data 638, the processor(s) 850 may the implement the actual reward that is indicated therein.

Referring back to FIGS. 2A-E, it should be noted that, despite what is depicted and what is described in connection with these figures, in some embodiments, various combinations of the servers 500, 600 and 800 may be combined into a single server such that their various functions are not so distributed among multiple computing devices.

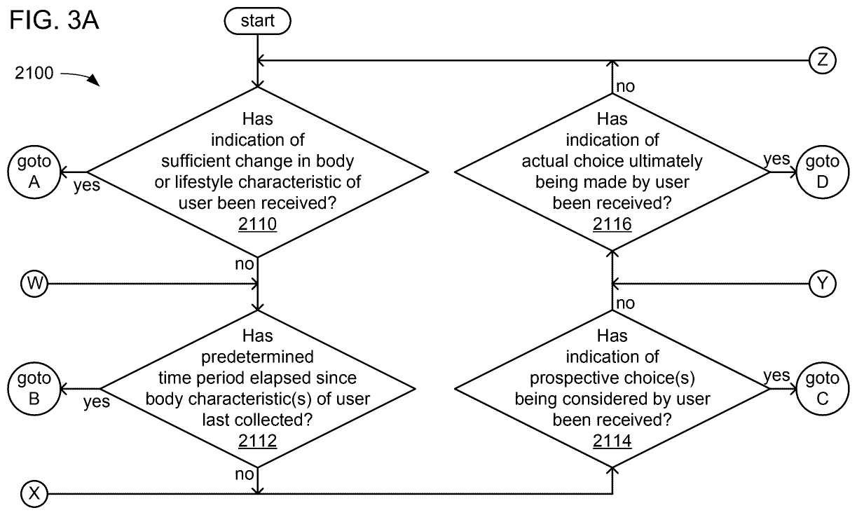

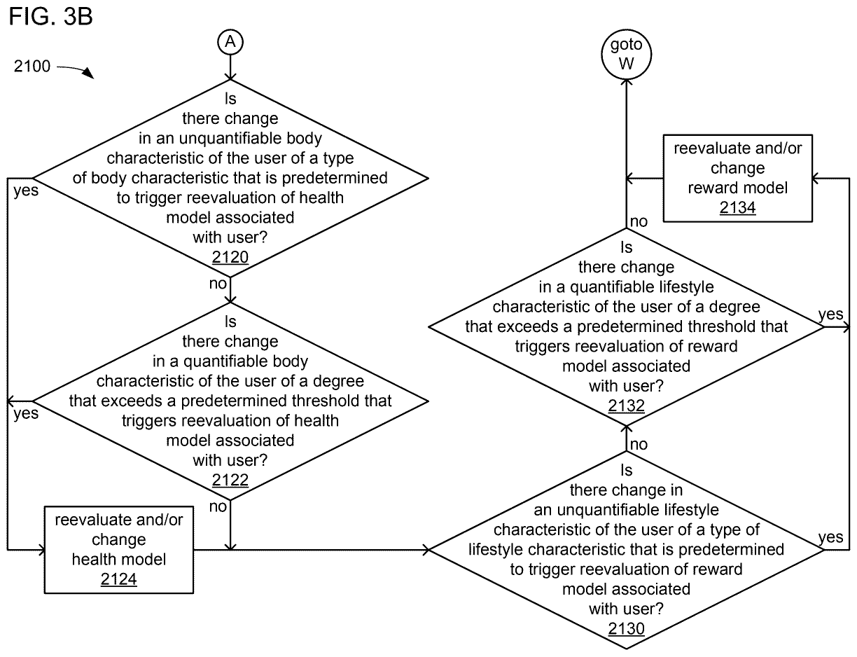

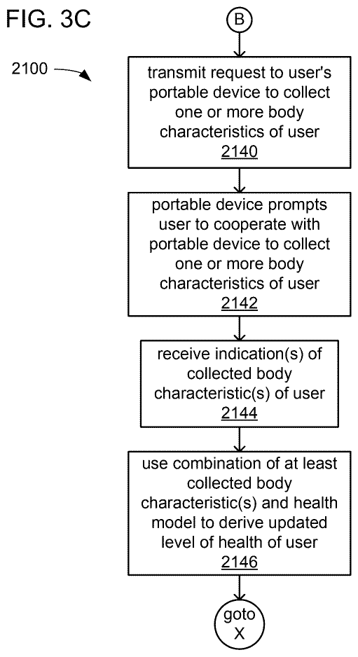

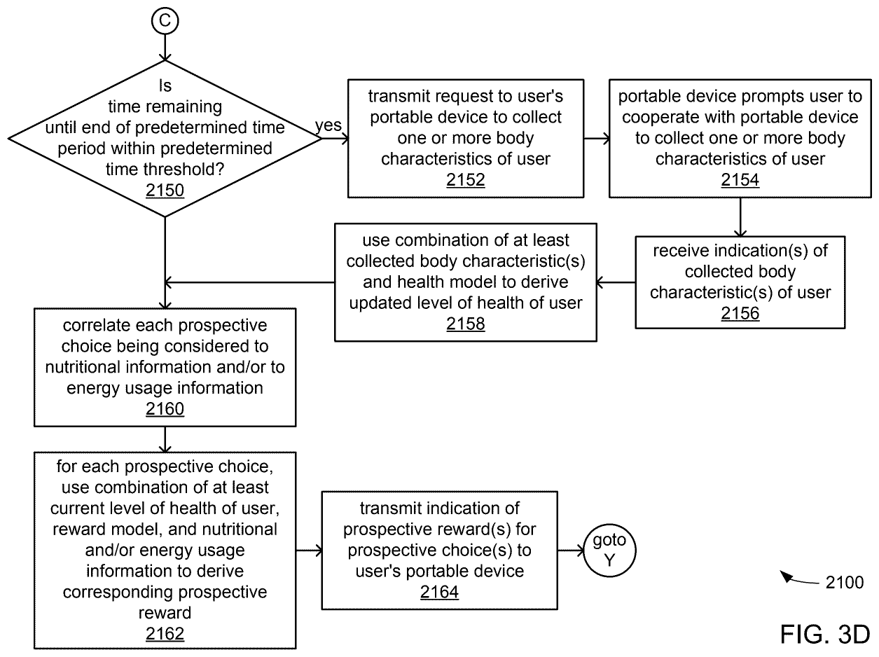

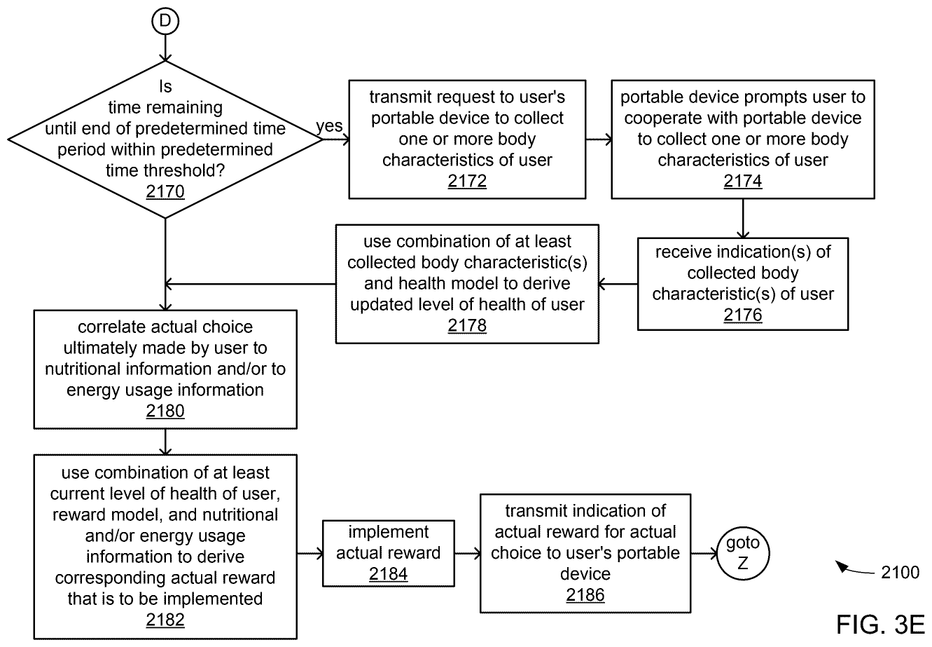

FIGS. 3A-E, taken together, present a flowchart 2100 depicting aspects of the operation of the example health rewards system 1000 for deriving and using rewards to encourage the making of health-related choices that are at least conducive to weight loss.

Turning to FIG. 3A, starting at 2110, one or more processor(s) of a health rewards system 1000 (e.g., one or more processors 550, 650 and/or 850 of the health rewards system 1000) may check whether an indication has been received of a change in a body or lifestyle characteristic of a user of the system (e.g., the user 100) that may be sufficient to trigger a change in the selection of a health model (e.g., one of the health models 570) and/or a reward model (e.g., one of the reward models 670) associated with the user. As has been discussed, indications of changes to a body characteristic may be received from a portable device of the user (e.g., the portable device 200) or from a stationary device installed at a location frequented by the user (e.g., the stationary device 300). As has also been discussed, indications of changes to a lifestyle characteristic may be received from various sources, such as from the portable device of the user, and/or from records of private institutions with which the user is associated (e.g., employer records, insurance company records, hospital medical records, academic records, etc.), and/or from government records (e.g., real estate title records, marriage records, etc.).

If such an indication has been received at 2110, then the processor(s) may proceed with determining whether or not the change in a body characteristic or in a lifestyle characteristic is of a type and/or of a degree that triggers a change in the health model and/or in the reward model associated with the user (as depicted in FIG. 3B).

However, if such an indication has not been received at 2110, then at 2112, the processor(s) may check whether a predetermined period of time has elapsed since body characteristics of the user were last collected. As has been discussed, there may be a predetermined period of time that sets an upper limit for the amount of time that is to occur between instances of collecting one or more body characteristics of each user of the system.

If such an amount of time has elapsed at 2112, then the processor(s) may proceed with cooperating with at least the portable device of the user to prompt the user for the collection of one or more body characteristics (as depicted in FIG. 3C).

However, if such an amount of time has not yet elapsed at 2112, then at 2114, the processor(s) may check whether an indication has been received of one or more prospective choices being considered by the user (e.g., prospective choices of food items and/or of types of physical activity). As has been discussed, such an indication may be received as an instance of choices data (e.g., an instance of the choices data 236) transmitted from the portable device of the user.

If such an indication has been received at 2114, then the processor(s) may proceed with deriving one or more corresponding prospective rewards to be presented to the user (as depicted in FIG. 3D).

However, if such an indication has not been received at 2114, then at 2116, the processor(s) may check whether an indication has been received of an actual choice ultimately being made by the user (e.g., an actual choice of a food item or of a type of physical activity). As has been discussed, such an indication may be received as an instance of choices data (e.g., an instance of the choices data 236) transmitted from the portable device of the user, and/or as an instance of choices data received from another device associated with a credit or debit card of the user (e.g., an instance of the choices data 838 received from the account server 800, and associated with the card 900).

If such an indication has been received at 2116, then the processor(s) may proceed with deriving and implementing a corresponding actual reward (as depicted in FIG. 3E).

However, if such an indication has not been received at 2116, then the processor(s) may return to checking whether an indication has been received of a change in a body or lifestyle characteristic of the user at 2110.

Turning to FIG. 3B, at 2120, the processor(s) may check whether there is a change to an unquantifiable body characteristic (e.g., a body characteristic that is either applicable to a user of the system 1000, or not) that is among a predetermined set of unquantifiable body characteristics where a change triggers a reevaluation of the selection of a health model that is associated with the user. Again, such body characteristics may include the presence or absence of a history of heart attack or heart failure, a presence of absence of a diagnosis of cardiac arrhythmia, the presence of absence of a history of cancer, a presence or absence of a history of alcohol or drug abuse, etc.

If at 2120, there is such a change to an unquantifiable body characteristic, then the selection of a health model may be reevaluated, and may also be changed, at 2124. It should be noted that the reevaluation of the selection of a health model at 2124 does not necessarily mean that the health model that was previously selected to be associated with the user will be changed as it may be that the reevaluation causes the previously selected health model to be selected again.

However, if at 2120, there is no such change to an unquantifiable body characteristic, then at 2122, the processor(s) may check whether there is a change to a quantifiable body characteristic that is among a predetermined set of quantifiable body characteristics where a change to a degree that exceeds a predetermined threshold of degree of change (e.g., a threshold of percentage of change) triggers a reevaluation of the selection a health model that is associated with the user. Again, such body characteristics may include weight, waist circumference (or other bodily dimension), blood pressure, heart rate, etc.

If at 2122, there is such a change to a quantifiable body characteristic, then the selection of a health model may be reevaluated, and may also be changed, at 2124.

However, if at 2122, there is no such change to a quantifiable body characteristic, then at 2130, the processor(s) may check whether there is a change to an unquantifiable lifestyle characteristic that is among a predetermined set of unquantifiable lifestyle characteristics where a change triggers a reevaluation of the selection of a reward model that is associated with the user. Again, such lifestyle characteristics may include whether a user is retired or working; whether a user is married or single; whether the user has minor children, or not; what religion a user is associated with; what state/province/country a user lives in and/or works in; whether a user works remotely, on the road or at a distinct worksite; etc.

If at 2130, there is such a change to an unquantifiable lifestyle characteristic, then the selection of a reward model may be reevaluated, and may also be changed, at 2134.

However, if at 2130, there is no such change to an unquantifiable lifestyle characteristic, then at 2132, the processor(s) may check whether there is a change to a quantifiable lifestyle characteristic that is among a predetermined set of quantifiable lifestyle characteristics where a change to a degree that exceeds a predetermined threshold of degree of change (e.g., a threshold of percentage of change) triggers a reevaluation of the selection a reward model that is associated with the user. Again, such lifestyle characteristics may include income, quantity of holidays and/or vacation days, quantity or range of hours and/or days worked per week, quantity or range of hours of sleep per day, quantity or range of calories consumed and/or used per day, quantity or range of hours of exercise (physical activity with a predetermined minimum level of exertion and/or minimum level of elevated heart rate) per day, etc.

If at 2132, there is such a change to a quantifiable lifestyle characteristic, then the selection of a reward model may be reevaluated, and may also be changed, at 2134.

Regardless of whether there is a reevaluation and/or change of model at either 2124 or 2134, the processor(s) may return to checking whether the predetermined period of time has elapsed since body characteristics of the user were last collected at 2112.

Turning to FIG. 3C, at 2140, the processor(s) may transmit a request to the portable device of the user to collect one or more body characteristics of the user. At 2142, the portable device may respond to the request by prompting the user to cooperate with at least the portable device to collect one or more body characteristics of the user. As has been discussed, it may be that sensors associated with the user's portable device (e.g., the sensor(s) 210p that may be built into the portable device 200 and/or other sensor(s) 210 that may be in wireless communication with the portable device 200), and/or sensors of a stationary device (e.g., sensor(s) 310 of the stationary device 300) may be used to collect various body characteristics of the user.

At 2144, the processor(s) may receive indication(s) of body characteristics collected from the user. As has been discussed, such indication(s) may be received as instance(s) of status data (e.g., instances of the status data 235 and/or of status data 335) that may be transmitted by the user's portable device and/or by a stationary device.

At 2146, the processor(s) may use a combination of at least the most recently collected body characteristics and the health model associated with the user to derive an new (updated) level of health of the user.

Then the processor(s) may return to checking whether an indication has been received of one or more prospective choices being considered by the user at 2114.

Turning to FIG. 3D, at 2150, the processor(s) may check whether the amount of time remaining before the end of the predetermined period of time is less than a predetermined threshold of time. Thus, even though the predetermined period of time since body characteristics of the user were last collected may not yet have elapsed, it may be that the end of that predetermined period of time is close enough that body characteristics of the user ought to be collected again, since an indication has been received of one or more prospective choices being considered.

If at 2150, the time remaining is less than the predetermined threshold of time, then the processor(s) may perform a set of operations similar to what is depicted in FIG. 3C. Specifically, at 2152, the processor(s) may transmit a request to the portable device of the user to collect one or more body characteristics of the user. At 2154, the portable device may respond to the request by prompting the user to cooperate with at least the portable device to collect one or more body characteristics of the user. At 2156, the processor(s) may receive indication(s) of body characteristics collected from the user. At 2158, the processor(s) may use a combination of at least the most recently collected body characteristics and the health model associated with the user to derive an new (updated) level of health of the user.

Regardless of whether body characteristics are again collected at 2152 through 2158, at 2160, the processor(s) may correlate each prospective choice of the one or more prospective choices to either amounts of nutrients (where the prospective choice is of a food item), or amount(s) of energy used (where the prospective choice is a type of physical activity, or a specified duration of a type of physical activity).

At 2162, for each prospective choice, the processor(s) may use a combination of at least 1) the most recently derived level of health of the user (e.g., a level of health specified in the most recently generated instance of the health data 536 associated with the user), 2) the reward model associated with the user, and 3) either the amounts of nutrients (where the prospective choice is a food item) or the amount(s) of energy used (where the prospective choice is a type of physical activity, or a specified duration of a type of physical activity) to derive a corresponding prospective reward.

At 2164, the processor(s) may transmit an indication of the prospective reward(s) for the prospective choice(s) to the user's portable device.

Then the processor(s) may return to checking whether an indication has been received of an actual choice ultimately being made by the user at 2116.

Turning to FIG. 3E, at 2170, the processor(s) may check whether the amount of time remaining before the end of the predetermined period of time is less than a predetermined threshold of time. Thus, even though the predetermined period of time since body characteristics of the user were last collected may not yet have elapsed, it may be that the end of that predetermined period of time is close enough that body characteristics of the user ought to be collected again, since an indication has been received of an actual choice having been made.

If at 2170, the time remaining is less than the predetermined threshold of time, then the processor(s) may perform a set of operations similar to what is depicted in FIG. 3C. Specifically, at 2172, the processor(s) may transmit a request to the portable device of the user to collect one or more body characteristics of the user. At 2174, the portable device may respond to the request by prompting the user to cooperate with at least the portable device to collect one or more body characteristics of the user. At 2176, the processor(s) may receive indication(s) of body characteristics collected from the user. At 2178, the processor(s) may use a combination of at least the most recently collected body characteristics and the health model associated with the user to derive an new (updated) level of health of the user.

Regardless of whether body characteristics are again collected at 2172 through 2178, at 2180, the processor(s) may correlate the actual choice to either amounts of nutrients (where the actual choice is of a food item), or amount(s) of energy used (where the actual choice is a type of physical activity, or a specified duration of a type of physical activity).

At 2182, the processor(s) may use a combination of at least 1) the most recently derived level of health of the user (e.g., a level of health specified in the most recently generated instance of the health data 536 associated with the user), 2) the reward model associated with the user, and 3) either the amounts of nutrients (where the actual choice is a food item) or the amount(s) of energy used (where the actual choice is a type of physical activity, or a specified duration of a type of physical activity) to derive the corresponding actual reward.

At 2184, the processor(s) may implement the actual reward.

At 2186, the processor(s) may transmit an indication of the prospective reward(s) for the prospective choice(s) to the user's portable device.

Then the processor(s) may return to checking whether an indication has been received of a change in a body or lifestyle characteristic of the user at 2110.

The present disclosure may employ a software stack to enlist the underlying tools, frameworks, and libraries used to build and run example applications of the present disclosure. Such a software stack may include PHP, React, Cassandra, Hadoop, Swift, etc. The software stack may include both frontend and backend technologies including programming languages, web frameworks servers, and operating systems. The frontend may include JavaScript, HTML, CSS, and UI frameworks and libraries. In one example, a MEAN (MongoDB, Express.js, Angular JS, and Node.js) stack may be employed. In another example, a LAMP (Linux, Apache, MySQL, and PHP) stack may be utilized.

Any suitable programming language can be used to implement the routines of particular examples including Java, Python, JavaScript, C, C++, assembly language, etc. Different programming techniques can be employed such as procedural or object oriented. The routines may execute on specialized processors.

As used in the description herein and throughout the claims that follow, “a,” “an,” and “the” include plural references unless the context clearly dictates otherwise. Also, as used in the description herein and throughout the claims that follow, the meaning of “in” includes “in” and “on” unless the context clearly dictates otherwise. While the above is a complete description of specific examples of the disclosure, additional examples are also possible. Thus, the above description should not be taken as limiting the scope of the disclosure which is defined by the appended claims along with their full scope of equivalents.

1. A system comprising:
a sensor to collect a body characteristic of a body of a user of the system;
a portable device to operate the sensor to collect the body characteristic, and comprising at least an input device to provide a user interface (UI) to enable the user to enter an identifier of an actual choice made by the user of a food item chosen by the user to eat or of a physical activity chosen by the user to engage in; and
at least one server comprising at least one processor and at least one storage to store instructions of at least one executable routine that, when executed by the at least one processor, cause the at least one processor to perform operations comprising:
receive, at the at least one server, and via a network from the portable device, an indication of the body characteristic, and the identifier of the actual choice;
derive a level of health of the user based on at least the body characteristic;
correlate the identifier of the actual choice to an amount associated with the actual choice, wherein the amount comprises either an amount of a nutrient provided by the food item, or an amount of energy used by engaging in the physical activity;
based on at least the level of health and the amount associated with the actual choice, derive an actual reward for the user that corresponds to the actual choice, wherein the actual reward comprises an amount of money, credit or redeemable tokens;
implement the actual reward by providing the user or taking from the user the amount of money, credit or redeemable tokens; and
transmit, from the at least one server, and via the network to the portable device, an indication of the actual reward to enable the portable device to present the actual reward to the user via the UI.

2. The system of claim 1, wherein the at least one processor performs further operations comprising:
prior to receiving the indication of the identifier of the actual choice, receive, at the at least one server, and via the network from the portable device, multiple identifiers of multiple prospective choices, wherein each prospective choice comprises a choice of a food item being considered by the user to eat or a physical activity being considered by the user to engage in;
for each prospective choice of the multiple prospective choices, perform operations comprising:
correlate a corresponding identifier of the multiple identifiers to an amount associated with the prospective choice, wherein the amount comprises either an amount of a nutrient provided by the food item, or an amount of energy used by engaging in the physical activity; and
based on at least the level of health and the amount associated with the prospective choice, derive a prospective reward of multiple prospective rewards for the user that corresponds to the prospective choice, wherein the prospective reward comprises an amount of money, credit or redeemable tokens; and
transmit, from the at least one server, and via the network to the portable device, an indication of the multiple prospective rewards to enable the portable device to present the multiple prospective rewards to the user via the UI to consider before the user makes the actual choice.

3. The system of claim 1, further comprising a stationary device at a fixed geographic location frequented by the user, wherein:
the portable device is configured to derive a current geographic location of the portable device from wireless signals received at the portable device;
the stationary device comprises another sensor to collect another body characteristic of the body of the user; and
the at least one processor is caused to perform further operations comprising:
receive, at the at least one server, and via the network from the portable device, an indication of the current geographic location of the portable device;
determine whether the fixed geographic location of the stationary device is currently within a threshold limit of distance from the current geographic location of the portable device;
in response to a determination that the fixed geographic location of the stationary device is currently within the threshold limit of distance from the current geographic location of the portable device, transmit, from the at least one server, and via the network to the portable device, a request for the portable device to prompt the user to proceed to the stationary device to enable the other sensor to collect the other body characteristic from the body of the user;
receive, at the at least one server, and via the network from either the portable device or the stationary device, an indication of the other body characteristic; and
derive the level of health of the user based on at least the other body characteristic in addition to the body characteristic.

4. The system of claim 1, wherein:
the sensor is configured to:
be worn on a portion of the body of the user to enable the sensor to collect the body characteristic continuously or at a recurring interval; and
wirelessly communicate with the portable device to relay multiple indications of the continuous or recurring collection of the body characteristic to the portable device to enable the portable device to transmit the indication of the body characteristic to the at least one server via the network; and
the portable device is configured to:
derive a quantity associated with the multiple indications of the continuous or recurring collection of the body characteristic; and
transmit the quantity to the at least one server via the network as the indication of the actual choice.

5. The system of claim 4, wherein:
the body characteristic comprises a heart rate; and
the quantity comprises a quantity of hours of engagement by the user in a physical activity based on at least one period of elevation of the heart rate above a threshold level indicative of the physical activity.

6. The system of claim 1, wherein:
the portable device is configured to derive a history of geographic locations of the portable device from wireless signals received at the portable device; and
the at least one processor is caused to perform further operations comprising:
receive, at the at least one server, and via the network from the portable device, indications of the history of geographic locations of the portable device as a lifestyle characteristic of a location of a home of the user or of a location of a worksite of the user; and
derive the actual reward based on at least the level of health, the lifestyle characteristic, and the amount associated with the actual choice.

7. The system of claim 1, wherein the sensor is selected from a group consisting of:
a wrist sensor configured to be worn on a wrist of the body of the user to measure an electrical or blood flow aspect of cardiovascular activity as the body characteristic;
a belt sensor configured to be worn about a waist of the body of the user to measure a circumference of the waist as the body characteristic; and
a shoe sensor configured to be worn on a foot of the user of the body of the user to measure a weight of the body of the user.

8. The system of claim 1, wherein the sensor is incorporated into the portable device to cooperate with a casing of the portable device to enable a weight of the body of the user to be measured when the user sits or stands on the portable device.

9. The system of claim 1, wherein:
prior to deriving the level of health of the user, the at least one processor selects a health model for the user from among a set of multiple health models based on a set of multiple body characteristics of the body of the user; and
deriving the level of health of the user based on at least the body characteristic comprises the at least one processor using the body characteristic as an input to the selected health model to generate the level of health from the selected health model.

10. The system of claim 9, wherein:
each health model of the set of multiple health models comprises a body mass index (BMI) growth chart; and
the level of health is expressed as a BMI.

11. The system of claim 1, further comprising a credit or debit card that enables the user to access an account associated with the user, wherein implementing the reward comprises adding the amount of money, credit or redeemable tokens to the account or subtracting the amount of money, credit or redeemable tokens from the account.

12. A computer-implemented method for rewarding healthier choices of a user comprising:
receiving, by at least one processor of at least one server of a health rewards system, and via a network from a portable device associated with a user of the system, an indication of a body characteristic of a body of the user, and an identifier of an actual choice made by the user, wherein:
the body characteristic is collected by a sensor associated with the portable device; and
the actual choice is of a food item chosen by the user to eat or a physical activity chosen by the user to engage in;
deriving, by the at least one processor, a level of health of the user based on at least the body characteristic;
correlating, by the at least one processor, the identifier of the actual choice to an amount associated with the actual choice, wherein the amount comprises either an amount of a nutrient provided by the food item, or an amount of energy used by engaging in the physical activity;
deriving, by the at least one processor, and based on at least the level of health and the amount associated with the actual choice, an actual reward for the user that corresponds to the actual choice, wherein the actual reward comprises an amount of money, credit or redeemable tokens;
implementing, by the at least one processor, the actual reward by providing the user or taking from the user the amount of money, credit or redeemable tokens; and
transmitting, by the at least one processor from the at least one server, and via the network to the portable device, an indication of the actual reward to enable the portable device to present the actual reward to the user via the UI.

13. The computer-implemented method of claim 12, further comprising:
prior to receiving the indication of the identifier of the actual choice, receiving, by the at least one processor at the at least one server, and via the network from the portable device, multiple identifiers of multiple prospective choices, wherein each prospective choice comprises a choice of a food item being considered by the user to eat or a physical activity being considered by the user to engage in;
for each prospective choice of the multiple prospective choices, performing, by the at least one processor, operations comprising:
correlating a corresponding identifier of the multiple identifiers to an amount associated with the prospective choice, wherein the amount comprises either an amount of a nutrient provided by the food item, or an amount of energy used by engaging in the physical activity; and
deriving, based on at least the level of health and the amount associated with the prospective choice, a prospective reward of multiple prospective rewards for the user that corresponds to the prospective choice, wherein the prospective reward comprises an amount of money, credit or redeemable tokens; and
transmitting, by the at least one processor from the at least one server, and via the network to the portable device, an indication of the multiple prospective rewards to enable the portable device to present the multiple prospective rewards to the user via the UI to consider before the user makes the actual choice.

14. The computer-implemented method of claim 12, further comprising:
receiving, by the at least one processor at the at least one server, and via the network from the portable device, an indication of a current geographic location of the portable device derived from wireless signals received at the portable device;
determining, by the at least one processor, whether a fixed geographic location of a stationary device is currently within a threshold limit of distance from the current geographic location of the portable device;
in response to a determination that the fixed geographic location of the stationary device is currently within the threshold limit of distance from the current geographic location of the portable device, transmitting, by the at least one processor from the at least one server, and via the network to the portable device, a request for the portable device to prompt the user to proceed to the stationary device to enable the other sensor to collect the other body characteristic from the body of the user;
receiving, by the at least one processor at the at least one server, and via the network from either the portable device or the stationary device, an indication of the other body characteristic; and
deriving, by the at least one processor, the level of health of the user based on at least the other body characteristic in addition to the body characteristic.

15. The computer-implemented method of claim 12, wherein:
the portable device is configured to derive a history of geographic locations of the portable device from wireless signals received at the portable device; and
the method further comprises:
receiving, by the at least one processor at the at least one server, and via the network from the portable device, indications of the history of geographic locations of the portable device as a lifestyle characteristic of a location of a home of the user or of a location of a worksite of the user; and
deriving, by the at least one processor, the actual reward based on at least the level of health, the lifestyle characteristic, and the amount associated with the actual choice.

16. The computer-implemented method of claim 12, wherein:
the method further comprises selecting, by the at least one processor, and prior to deriving the level of health of the user, a health model for the user from among a set of multiple health models based on a set of multiple body characteristics of the body of the user; and
deriving the level of health of the user based on at least the body characteristic comprises, using, by the at least one processor, the body characteristic as an input to the selected health model to generate the level of health from the selected health model.

17. The computer-implemented method of claim 16, wherein:
each health model of the set of multiple health models comprises a body mass index (BMI) growth chart; and
the level of health is expressed as a BMI.

18. A non-transitory machine-readable storage medium including instructions of a executable routine stored thereon which, when executed by at least one processor of at least one server of a health rewards system, cause the at least one processor to perform operations comprising:
receive, by the at least one processor at the at least one server, and via a network from a portable device associated with a user of the system, an indication of a body characteristic of a body of the user, and an identifier of an actual choice made by the user, wherein:
the body characteristic is collected by a sensor associated with the portable device; and
the actual choice is of a food item chosen by the user to eat or a physical activity chosen by the user to engage in;
derive, by the at least one processor, a level of health of the user based on at least the body characteristic;
correlate, by the at least one processor, the identifier of the actual choice to an amount associated with the actual choice, wherein the amount comprises either an amount of a nutrient provided by the food item, or an amount of energy used by engaging in the physical activity;
derive, by the at least one processor, and based on at least the level of health and the amount associated with the actual choice, an actual reward for the user that corresponds to the actual choice, wherein the actual reward comprises an amount of money, credit or redeemable tokens;
implement, by the at least one processor, the actual reward by providing the user or taking from the user the amount of money, credit or redeemable tokens; and
transmit, by the at least one processor from the at least one server, and via the network to the portable device, an indication of the actual reward to enable the portable device to present the actual reward to the user via the UI.

19. The non-transitory machine-readable storage medium of claim 18, wherein that least one processor is further caused to perform operations comprising:
prior to receiving the indication of the identifier of the actual choice, receive, by the at least one processor at the at least one server, and via the network from the portable device, multiple identifiers of multiple prospective choices, wherein each prospective choice comprises a choice of a food item being considered by the user to eat or a physical activity being considered by the user to engage in;
for each prospective choice of the multiple prospective choices, perform, by the at least one processor, operations comprising:
correlate a corresponding identifier of the multiple identifiers to an amount associated with the prospective choice, wherein the amount comprises either an amount of a nutrient provided by the food item, or an amount of energy used by engaging in the physical activity; and
derive, based on at least the level of health and the amount associated with the prospective choice, a prospective reward of multiple prospective rewards for the user that corresponds to the prospective choice, wherein the prospective reward comprises an amount of money, credit or redeemable tokens; and
transmit, by the at least one processor from the at least one server, and via the network to the portable device, an indication of the multiple prospective rewards to enable the portable device to present the multiple prospective rewards to the user via the UI to consider before the user makes the actual choice.

20. The non-transitory machine-readable storage medium of claim 18, wherein that least one processor is further caused to perform operations comprising:
receive, by the at least one processor at the at least one server, and via the network from the portable device, an indication of a current geographic location of the portable device derived from wireless signals received at the portable device;
determine, by the at least one processor, whether a fixed geographic location of a stationary device is currently within a threshold limit of distance from the current geographic location of the portable device;
in response to a determination that the fixed geographic location of the stationary device is currently within the threshold limit of distance from the current geographic location of the portable device, transmit, by the at least one processor from the at least one server, and via the network to the portable device, a request for the portable device to prompt the user to proceed to the stationary device to enable the other sensor to collect the other body characteristic from the body of the user;
receive, by the at least one processor at the at least one server, and via the network from either the portable device or the stationary device, an indication of the other body characteristic; and
derive, by the at least one processor, the level of health of the user based on at least the other body characteristic in addition to the body characteristic.
